(19) United States
(12) Patent Application Publication
(10) Pub. No.: US 2019/0177238 A1
(43) Pub. Date: Jun. 13, 2019

(54) THIN FILM CERAMICS AND CERMETS PROCESSED USING NANOPOWDERS OF CONTROLLED COMPOSITIONS

(71) Applicant: The Regents of The University of Michigan, Ann Arbor, MI (US)

(72) Inventors: Eongyu YI, Ann Arbor, MI (US); Richard M. LAINE, Ann Arbor, MI (US)

(21) Appl. No.: 16/089,784

(22) PCT Filed: Mar. 28, 2017
(86) PCT No.: PCT/US2017/024573

§ 371 Date: Sep. 28, 2018

Related U.S. Application Data
(60) Provisional application No. 62/313,930, filed on Mar. 28, 2016.

(51) Int. Cl. C04B 35/622; C04B 35/626; C04B 35/634; C04B 35/64; C04B 35/638; C04B 35/632; C04B 35/486; C04B 35/01; C04B 35/44; C04B 35/117; C04B 35/488; C04B 37/00; H01M 10/0525; H01M 10/0562; H01M 10/0585; B22F 7/04

(52) U.S. Cl. CPC C04B 35/62218; B22F 2302/35; C04B 35/62655; C04B 35/6342; C04B 35/64; C04B 35/6264; C04B 35/638; C04B 35/6267; C04B 35/63424; C04B 35/632; C04B 35/6263; C04B 35/486; C04B 35/016; C04B 35/44; C04B 35/117; C04B 35/4885; C04B 37/001; H01M 10/0525; H01M 10/0562; H01M 10/0585; B22F 7/04; C04B 2235/3248; C04B 2235/3268; C04B 2235/3409; C04B 2235/3217; C04B 2235/3222; C04B 2235/5445; C04B 2235/604; C04B 2235/606; C04B 2235/612; C04B 2235/6562; C04B 2235/95; C04B 2235/96; C04B 2237/34; C04B 2237/348; H01M 2300/0077; C04B 35/6261

(57) ABSTRACT

A method of making a thin film is provided. The method includes ball milling a suspension including a nanopowder, an additive component, and a solvent to generate a suspension of milled nanopowder, disposing a layer of the suspension of milled nanopowder onto a substrate, drying the layer by removing at least a portion of the solvent to form a green film, compressing the green film to form a compressed green film, debindering the compressed green film to form a debindered film, and sintering the debindered film to generate the thin film. The additive component includes a component selected from the group consisting of a dispersant, a binder, a plasticizer, and combinations thereof.

### CROSS-REFERENCE TO RELATED APPLICATIONS

This application claims the benefit of U.S. Provisional Application No. 62/313,930, filed on Mar. 28, 2016. The entire disclosure of the above application is incorporated herein by reference.

### GOVERNMENT INTEREST

This invention was made with government support under grant DMR1105361 awarded by the National Science Foundation. The government has certain rights in the invention.

### FIELD

The present disclosure relates to thin film ceramics and cermets processed using nanopowders of controlled compositions.

### BACKGROUND

This section provides background information related to the present disclosure which is not necessarily prior art. This section provides a general summary of the disclosure, and is not a comprehensive disclosure of its full scope or all of its features.

There is a continual search for materials and methods that offer access to very thin ceramic, ceramic-metal films and/or multilayer laminates that are dense, partially porous or porous for multiple applications ranging from membranes for oxygen separation from air, solid oxide fuel cell electrodes and electrolytes, solid electrolytes for lithium batteries, supported catalysts for multiple applications.

One of the major problems with producing very thin films arises because commercially available ceramic, metal or metal nitride powders typically have average particle sizes of 1-10 μm and only in rare instances is it possible to find commercially available powders with particle sizes below about 500 nm. Even in instances where such particles are available there remain serious obstacles to producing thin, dense or partially porous or porous films that offer sufficient mechanical strength because the process of densifying these films often leads to the growth of very large grains (>3 μm) in the final film, making them very susceptible to brittle failure especially in ceramic films thinner than about 30 μm because such large grains offer relatively long grain boundaries that offer low energy avenues for crack propagation greatly limiting their utility in manufacturing products where structural integrity during manufacture and use is paramount.

Furthermore, most methods of processing thin to very thin films either work poorly or are expensive. Thus ceramic films thinner than about 40 μm are very difficult to make using doctor blading in part because of the starting particle sizes but in part because of the high viscosities generated when the loading of ceramic particles in the slip becomes very high. In these instances the slip is pushed across the surface to be coated creating drag, compression and as a consequence uneven film surfaces and thicknesses can result due to die swell issues.

To address these shortcomings, the current technology provides methods for manufacturing metal oxide and metal oxide/metal and metal oxide/metal nitride single and multilayer thin films (e.g., having thicknesses of about 5 to about 150 μm) by casting single layer polymer/nanopowder composite films and where desirable, laminating layers of the same or different oxides, or cutting of the films at certain angles to obtain selected shapes, e.g., sharp edges. The resulting polymer films are heated to first remove binder and then to sinter them to partially porous or dense single metal oxide films, multilayer metal oxide films, or metal/metal oxide or metal nitride/metal oxide composite, thin film laminates. As will be discussed further herein, the nanopowders used for such process are typically produced using liquid feed-flame spray pyrolysis (LF-FSP as described in the prior art as incorporated herein) process; although this is not the only possible nanopowder source.

### SUMMARY

In certain aspects, the current technology provides the use of nanopowders to overcome the issues of particle size noted above and the use of wire-wound roller coating, wherein the dispersed powder coating system is dragged across the substrate as opposed to being pushed across the substrate in doctor blading avoiding for example die swell problems which seems to offer a significant processing advantage allowing processing of ceramic thin films at thicknesses below 10 μm but most commonly between 10 and 40 μm. Furthermore the use of nanopowders provides dense films where final grain sizes are less than or equal to about 3 μm and in certain variations, less than or equal to about 500 nm.

Further, the use of liquid feed flame spray pyrolysis (LF-FSP) provides a method of incrementally varying nanopowder compositions with very exacting control of element compositions enabling very fine control of final thin film properties.

In the following sections a discussion of the processing of sets of thin ceramic films, composites and laminates beginning with lithium ion conducting ceramic materials are provided.

Nanopowders synthesized using LF-FSP can be used directly to formulate suspensions that can then be cast to form thin polymer/nanopowder composite thin films. These thin films can be laminated at this stage to form multilayer composites or heat treated to undergo binder burnout and then laminated or sintered and then laminated and heated to form interfaces resulting in ceramic thin films of desired characteristics. Target compositions of nanopowders are produced by combusting aerosols of alcoholic solutions of selected metalloorganic precursors in an oxidizing atmosphere.

Example precursors in the synthesis of Li₇La₃Zr₂O₁₂, Y₃Al₅O₁₂—Al₂O₃ composites, Al₂O₃—Y₃Al₅O₁₂—ZrO₂ composites, Ni—Y₃Al₅O₁₂ composites, and ZrO₂/A₂O₃—Ni composites include but are not limited to lithium propionate, lanthanum isobutyrate, zirconium isobutyrate, alumatrane, yttrium propionate, nickel acetate tetrahydrate. Nanopowders with average particle sizes below 100 nm can be produced by combusting aerosols of precursor solutions at concentrations of about 1 to about 20 wt. % ceramic yields, optionally at less than about 5 wt. %.

Synthesized nanopowders are dispersed in ethanol or other solvent with ball milling where needed with about 1 to about 3 wt. % of appropriate dispersant in certain variations. These dispersions are settled for from about 4 to about 30 hours and then the supernatant containing the stable dispersion is decanted, solvent is removed and the resulting powders are dried at 20° to 100° C. in ambient air, nitrogen, argon or under vacuum.

The recovered powders are used to formulate suspensions that are then cast onto a flexible substrate and subsequently dried and peeled off. The green films can be used as is or laminated and thermo-compressed to improve green densities and sintered in a controlled ramp rate, peak temperature, dwell time, and atmosphere to induce in some instances reduction/nitridation of selected components of the nanopowders and to sinter to a desired characteristic partial or complete density of ceramic, ceramic-metal or ceramic-nitride composite thin films.

In some instances, the dense sintered films can be coated with a thin layer less than or equal to about 1 μm of a second ceramic material to seal the surface against degradation due to exposure simply to standard manufacturing conditions or as a prelude to introducing a second or tertiary layer as part of a multi-lamination process.

In certain variations, the current technology provides a method of making a thin film. The method includes ball milling a suspension including a nanopowder, an additive component, and a solvent to generate a suspension of milled nanopowder, wherein the additive component is selected from the group consisting of a dispersant, a binder, a plasticizer, and combinations thereof. The method also includes disposing a layer of the suspension of milled nanopowder onto a substrate, drying the layer by removing at least a portion of the solvent to form a green film, compressing the green film to form a compressed green film, debindering the compressed green film to form a debindered film, and sintering the debindered film to generate the thin film.

In one aspect, the nanopowder comprises nanopowder particles having a diameter of less than or equal to about 500 nm.

In one aspect, the nanopowder is made by liquid-feed flame spray pyrolysis, co-precipitation, or sol-gel synthesis.

In one aspect, the nanopowder includes nanopowder particles composed of a material selected from the group consisting of oxides, carbonates, carbides, nitrides, oxycarbides, oxynitrides, oxysulfides, and combinations thereof.

In one aspect, the solvent includes water, methanol, ethanol, propanol, butanol, xylene, hexane, methyl ethyl ketone, acetone, toluene, or a combination thereof.

In one aspect, the additive component includes a dispersant selected from the group consisting of polyacrylic acid, bicine, citric acid, steric acid, fish oil, phenylphosphonic acid, phosphoric acid, ammonium polymethacrylate, organosilanes, and combinations thereof.

In one aspect, the additive component includes a binder selected from the group consisting of polyvinyl butyral, polyvinyl acetate, methyl cellulose, ethyl cellulose, polyacrylate esters, polyurethane, polyethylene glycol, acrylic compounds, polystyrene, polyvinyl alcohol, polymethylmethacrylate, polybutylmethacrylate, and combinations thereof.

In one aspect, the additive component includes a plasticizer selected from the group consisting of benzyl butyl phthalate, acetic acid alkyl esters, bis[2-(2-butoxyethoxy)ethyl] adipate, 1,2-Dibromo-4,5-bis(octyloxy)benzene, dibutyl adipate, dibutyl itaconate, dibutyl sebacate, dicyclohexyl phthalate, diethyl adipate, diethyl azelate, di(ethylene glycol) dibenzoiate, diethyl sebacate, diethyl succinate, diheptyl phthalate, diisobutyl adipate, diisobutyl fumarate, diisobutyl phthalate, diisodecyl adipate, diisononyl phthalate, dimethyl adipate, dimethyl azelate, dimethyl phthalate, dimethyl sebacate, dioctyl terephthalate, diphenyl phthalate, di(propylene glycol) dibenzoate, dipropyl phthalate, ethyl 4-acetylbutyrate, 2-(2-ethylhexyloxy)ethanol, isodecyl benzoate, isooctyl tallate, neopentyl glycol dimethylsulfate, 2-nitrophenyl octyl ether, poly(ethylene glycol) bis(2-ethylhexanoate), poly(ethylene glycol) dibenzoate, poly(ethylene glycol) dioleate, poly(ethylene glycol) monolaurate, poly(ethylene glycol) monooleate, poly(ethylene glycol) monooleate, sucrose benzoate, 2,2,4-trimethyl-1,3-pentanediol dibenzoate, trioctyl timelitate, and combinations thereof.

In one aspect, the suspension has a nanopowder concentration of greater than or equal to about 5 vol. % to less than or equal to about 50 vol. %.

In one aspect, the disposing is performed by bar coating, wire wound rod coating, drop casting, spin coating, doctor blading, dip coating, or spray coating.

In one aspect, after the drying and before the sintering, the method further includes removing the green film from the substrate, and cutting the green film into a predetermined shape and size.

In one aspect, the method further includes disposing the green film onto either a second green film or onto a metal foil to form a green bilayer film, and compressing, and debindering the green bilayer film to form a debindered bilayer film, and sintering the debindered bilayer film to form the thin film, wherein the thin film is a bilayer composite thin film.

In one aspect, the bilayer composite thin film includes a first side comprising a ceramic with a rare earth element dopant, and an opposing second side including a metal, wherein the first side is thermo-luminescent.

In one aspect, the nanopowder includes at least one of Li_{6.25}Al_{0.25}La₃Zr₂O₁₂ and Li_{6.25}Ga_{0.25}La₃Zr₂O₁₂, and prior to the ball milling, the method further includes generating the nanopowder by aerosolizing and combusting a solution including a lithium propionate, alumatrane or gallium-atrane, lanthanum isobutyrate, and zirconium isobutyrate in an oxidizing atmosphere using liquid-feed flame spray pyrolysis to generate a nanopowder including Li_{6.25}Al_{0.25}La₃Zr₂O₁₂ nanoparticles or Li_{6.25}Ga_{0.25}La₃Zr₂O₁₂ nanoparticles.

In another variation, the current technology provides a thin film generated by the above method.

In yet another variation, the current technology provides a method of making a thin film that includes combining a nanopowder generated by liquid-feed flame spray pyrolysis with a solvent including a binder and a plasticizer to generate a nanopowder suspension, the nanopowder including nanoparticles have an average diameter of less than or equal to about 500 nm; ball milling the nanopowder suspension for a time of greater than or equal to about 6 hours to less than or equal to about 48 hours using a milling media that is at least partially composed of a material contained in the nanopowder to generate a milled suspension; casting a layer of the milled suspension on a substrate by bar coating or wire wound rod coating; drying the layer on the substrate by removing at least a portion of the solvent to form a green film; thermo-compressing the green film using a uni-axial press, a bi-axial press, a tri-axial press, or a roll press to form a compressed green film; debindering the compressed green film to form a debindered film; and sintering the debindered film to form the thin film.

In one aspect, the method also includes, after the removing and prior to the thermo-compressing, disposing the green film on a second green film made by the same method but with a different nanopowder, wherein after the sintering a composite thin film comprising a plurality of layers is generated.

In one aspect, the nanopowder suspension includes a dopant.

In one aspect, the substrate includes a biaxially-oriented polyethylene terephthalate polymer.

In one aspect, the thin film has a thickness of greater than or equal to about 1 μm to less than or equal to about 100 μm.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flow chart showing a method for making a thin film according to various aspects of the current technology.

FIG. 2 is a process flow chart for manufacturing thin ceramic films.

FIG. 3 is a SEM fracture surface image of sintered Li₇La₃Zr₂O₁₂ (LLZO) film.

FIG. 4 is a XRD of sintered, single phase LLZO film.

FIG. 5 shows typical Nyquist plots of sintered LLZO film.

FIG. 6 shows temperature dependence of ionic conductivities.

FIG. 7 is a SEM of sintered LLZO-Mg film.

FIG. 8 is a XRD of sintered, single phase LLZO-Mg.

FIGS. 9A-9B show Nyquist plots of sintered LLZO-Mg film.

FIG. 10 is a SEM of sintered Li_{6.5}La₃Zr_{1.5}Ta_{0.5}O₁₂—La₂Zr₂O₇ film.

FIG. 11 is a XRD spectrum of the Li_{6.5}La₃Zr_{1.5}Ta_{0.5}O₁₂—La₂Zr₂O₇ film.

FIG. 12 is a SEM fracture surface image of sintered LiMn₂O₄—Li₂B₄O₇ film.

FIG. 13 is a XRD of sintered LiMn₂O₄—Li₂B₄O₇ film.

FIG. 14 shows green films of LiMn₂O₄—Li₂B₄O₇ mixture processed as described in Example 3 (left) and after lamination of Li₂B₄O₇ green film on top (right).

FIG. 15 is debindered LiMn₂O₄—Li₂B₄O₇/Li₂B₄O₇ lamellar composite films. Film on left shows LiMn₂O₄—Li₂B₄O₇ side, and film on right shows Li₂B₄O₇ coated side. Note the color difference suggesting a separate phase.

FIG. 16 is a SEM fracture surface image of sintered film of Al₂O₃—Y₃Al₅O₁₂.

FIG. 17 is a XRD of sintered film of Al₂O₃—Y₃Al₅O₁₂.

FIG. 18 is a SEM of sintered film of Al₂O₃—Y₃Al₅O₁₂—Y:ZrO₂ composite.

FIG. 19 is a XRD of sintered film of Al₂O₃—Y₃Al₅O₁₂—Y:ZrO₂ composite.

FIG. 20 is a SEM fracture surface image of sintered film of Ni—Y₃Al₅O₁₂ intermixed composite.

FIG. 21 is a XRD of sintered film of Ni—Y₃Al₅O₁₂.

FIGS. 22A-22B show XRD. FIG. 22A shows a XRD of single phase YAG film and FIG. 22B shows a XRD of single phase Ni film.

FIG. 23 is a SEM image of lamellar YAG/Ni film. Outermost layers are YAG

FIG. 24 is a SEM image of a sintered Ni—ZrO₂/Al₂O₃ lamellar composite.

FIG. 25 is a SEM image of a sintered ZrO₂—Al₂O₃ composite with a sharp edge.

FIG. 26 is a flow chart showing a comparison of potential processing routes. Direct processing of LF-FSP made nanopowders provides a processing short-cut while significantly reducing required external energy to reach high densities at the same time.

FIGS. 27A-27E shows an apparatus and characterization of the flame made nanoparticles. FIG. 27A: LF-FSP is an iteration of aerosol combustion synthesis. Metalloorganic precursors dissolved in ethanol are aerosolized and combusted in a controlled fashion generating nanoparticles recovered in electrostatic precipitators. FIG. 27B: SEM image of as-produced spherical nanopowders. The scale bar is 500 nm. FIG. 27C: XRD of as-produced powder shows a mixture of Li₂CO₃ and off-stoichiometric La₂Zr₂O₇ phase, not c-LLZO. FIG. 27D: TGA of as-produced powder shows an endothermic mass loss at >700° C. ascribed to melting of Li₂CO₃ and loss of CO₂. FIG. 27E: FTIR confirms vCO₃ (≈1500 cm-1), and vM-O (<600 cm-1).

FIG. 28 is a Low magnification SEM image of as-produced nanopowders. This figure demonstrates that LF-FSP made nanopowders are spherical with narrow size distributions. Particles are agglomerated (physically bonded), but not aggregated (chemically bonded). The scale bar is 5 μm.

FIG. 29 is an XRD scan of as-produced LLZO with α-Al₂O₃ internal standard.

FIG. 30 is a TGA-DSC of LLZO green film.

FIG. 31 shows XRD scans of LLZO films heated to 800 and 1000° C. for 1 h. A film heated to 800° C./1 h shows primarily t-LLZO whereas at 1000° C./1 h a mixture of c-LLZO and t-LLZO forms, indicating Li₂O is volatilized at or near 1000° C. Selected major c-LLZO peaks are marked as red drop lines to mark the difference.

FIGS. 32A-32G show a characterization of the LLZO films sintered at selected temperatures. FIGS. 32A and 32B: SEM fracture surface image of films sintered at 1080° C./1 h shows mixed inter- and trans-granular fracture mode along with closed pores. FIGS. 32C and 32D: SEM fracture surface image of films sintered at 1090° C./1 h shows trans-granular fracture mode and very high relative density. FIGS. 32E and 32F: SEM fracture surface image of film sintered at 1100° C./1 h. FIG. 32G: XRD of sintered films. Single phase LLZO is observed for 1080° C., and trace amount of La₂Zr₂O₇ for 1090° C. sintered films, whereas 1100° C. sintered films show noticeable secondary phase peaks. Scale bars, 20 μm for FIGS. 32A, 32C, and 32E and 5 μm for FIGS. 32B, 32D, and 32F.

FIGS. 33A-33E show the effect of green film thicknesses on the final microstructure and phase composition at fixed sintering condition (1090° C./1 h). FIG. 33A: SEM fracture surface image of sintered 22 μm thick green film. FIG. 33B: SEM fracture surface image of sintered 44 μm thick green film. FIG. 33C: SEM fracture surface image of sintered 73 μm thick green film. FIG. 33D: Surface/volume ratio dictates lithium loss rate and drastically changes at film thicknesses below 100 μm. Simplicity sake, it is assumed there is no porosity. FIG. 33E: Phase composition changes with film thicknesses although all of them were heated to same condition of 1090° C./1 h. Scale bars are 10 μm for FIGS. 33a, 33B, and 33C.

FIGS. 34A-34B show electrochemical properties of sintered LLZO films.

FIG. 34A: Nyquist plots show initial semicircle due to ion conduction at the high frequency range followed by a spike ascribed to blocking electrode effect at lower frequencies. Bulk resistance for measurement at −15° C. is shown as an example. Dimensional variables are factored in to both axes. FIG. 34B: Ionic conductivities of LLZO rises with temperature showing Arrhenius trend.

FIG. 35 is a SEM fracture surface image of c-LLZO film sintered at 1100° C. for 1 hour.

FIGS. 36A-36B. FIG. 36A is a SEM fracture surface image of a c-LLZO film heated to below sintering temperature. The scale bar is 20 μm. FIG. 36B is a Nyquist plot of the c-LLZO film heated to below sintering temperature.

FIGS. 37A-37C show translucent sintered LLZO films. FIG. 37A: Photograph of LLZO film sintered within the optimal range. “c-LLZO” printed on the background is visible due to low thicknesses (<30 μm). The sintered film is roughly 2×2 cm². FIG. 37B: Sintered thin film was placed on the side of a 100 ml beaker and manually pressed to demonstrate flexibility. FIG. 37C: Surface SEM image of the sintered film. Scale bar is 1 cm for FIG. 37A, and 20 μm for 37C.

FIGS. 38A-38B show the effect of green film thicknesses (Li loss rate) on microstructure and phase composition. FIG. 38A shows XRD scans of LLZO films with different green film thicknesses heated to 1090° C. for 1 h. FIG. 38B shows SEM fracture surface images of the LLZO films. The thicknesses labelled are green film, not sintered film thicknesses. La₂O₃ and La₂Zr₂O₇ peak intensities rise with decreasing thickness. Films too thick result in t-LLZO as observed by peak splitting for 65 and 73 μm thick films. Microstructures of sintered films are affected by lithium content as secondary phases, including t-LLZO, have different sintering temperatures compared to c-LLZO. The scale bar in FIG. 38B is 20 μm.

FIGS. 39A-39B. FIG. 39A is a XRD pattern derived from [NiO]_{0.25}[Al₂O₃]_{0.75} nanopowders and FIG. 39B is a SEM image of as-produced [NiO]_{0.25}[Al₂O₃]_{0.75} nanopowders.

FIG. 40 shows TGA-DTA curves of [NiO]_{0.25}[Al₂O₃]_{0.75} green films heated at 10° C./min in air.

FIG. 41 shows XRD patterns of [NiO]_{0.25}[Al₂O₃]_{0.75} films sintered at 1100-1500° C./air.

FIGS. 42A-42F show SEM images of fracture surface morphologies for [NiO]_{0.25}[Al₂O₃]_{0.75} films sintered in air at (FIG. 42A) 1000° C./1 h, (FIG. 42B) 1100° C./1 h, (FIG. 42C) 1200° C./1 h, (FIG. 42D) 1400° C./1 h, (FIG. 42E) 1500° C./1 h, and (FIG. 42F) 1500° C./3 h.

FIGS. 43A and 43B are SEM images of (FIG. 43A) surface and (FIG. 43B) fracture morphologies of [NiO]_{0.25}[Al₂O₃]_{0.75} films (as-sintered at 1500° C./3 h) after thermal etching at 1400° C./30 min/air. These films offer grains with average sizes of 1.1±0.3 μm.

FIG. 44 shows XRDs of [NiO]0.25[Al₂O₃]_{0.75} films sintered at 1500° C./3 h/air, then at 1000-1100° C./H₂.

FIG. 45 shows TGA-DTA of [NiO]_{3.25}[Al₂O₃]_{0.75} films (reduced at 1100° C./7 h/H₂) after heating at 10° C./min in O₂. Temperatures were limited to 600° C. to protect the instrument against damage from NiO evaporation at higher temperatures.

FIGS. 46A-46B show SEM images of (FIG. 46A) fracture surface and (FIG. 46B) surface morphologies of [NiO]_{0.25}[Al₂O₃]_{0.75} films after heating at 1100° C./7 h/H₂.

FIGS. 47A-47C are images of transparent, flexible, dense [NiO]_{0.25}[Al₂O₃]_{0.75} (NiO.3Al₂O₃) thin films. (FIG. 47A) Optical images of as-sintered films. ‘NiO.3Al₂O₃’ printed on the background is visible. Films (ca. 1.8×1.2 cm) show decent flexibility inherent to NiAl₂O₄—Al₂O₃ thin ceramics. (FIG. 47B) SEM images of fractured films showing a thickness of 15±2 μm, and trans-/inter-granular mixed fracture. Both contribute to the excellent flexibility of films. (FIG. 47C) Optical images of as-reduced films offering good flexibility as before.

FIG. 48 shows XRDs of [NiO]_{0.5}[Al₂O₃]_{0.5} films sintered at 1550° C./3 h/air, then at 1050-1100° C./7 h/5% H₂.

FIG. 49 shows TGA-DTA of [NiO]_{0.5}[Al₂O₃]_{0.5} films (reduced at 1100° C./7 h/5% H₂) on heating 10° C./min/O₂.

FIGS. 50A-50B are SEM images of (FIG. 50A) fracture surface and (FIG. 50B) surface morphologies of [NiO]_{0.5}[Al₂O₃]_{0.5} films after heating at 1100° C./7 h in H₂.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

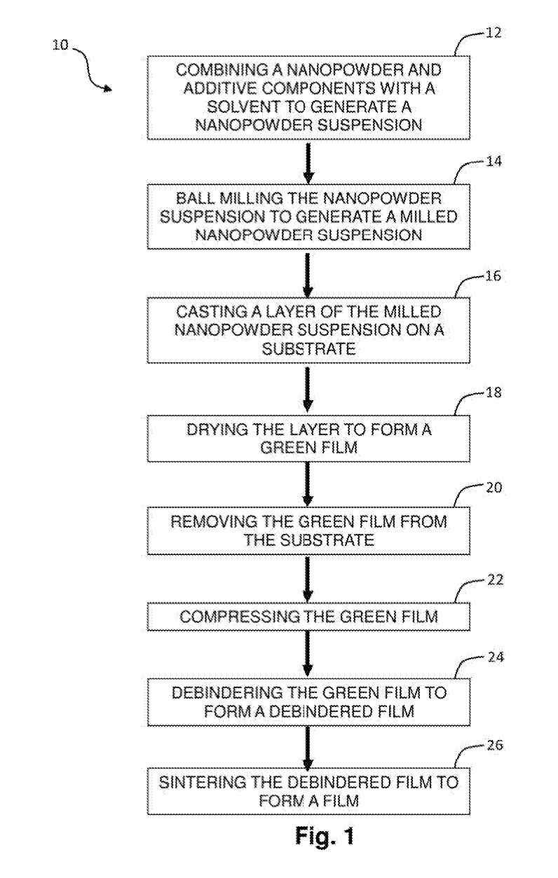

As shown in FIG. 1, the current technology provides a method 10 for making a thin film. The thin film comprises a single layer or a plurality of layers, i.e., composite films. As shown in FIG. 1, in block 12 the method 10 comprises combining a nanopowder and additive components with a solvent to generate a nanopowder suspension. The nanopowder suspension has a nanopowder concentration of greater than or equal to about 1 vol. % to less than or equal to about 75 vol. % or greater than or equal to about 5 vol. % to less than or equal to about 50 vol. %

As describe further below, the nanopowder comprises nanoparticles having an average diameter of less than or equal to about 500 nm, less than or equal to about 250 nm, less than or equal to about 100 μm, or less than or equal to about 50 nm. The nanoparticles are composed of a material selected from the group consisting of oxides, carbonates, carbides, nitrides, oxycarbides, oxynitrides, oxysulfides, and combinations thereof. The nanoparticles can include components selected from the group consisting of group IA elements, group IIA elements, group IIIA elements, transition metals, lanthanide metal, actinide metals, group IIIB elements, group IVA elements, group VA elements, oxides, thereof, phosphates thereof, nitrides thereof, carbides thereof, and combinations thereof. In some aspects, the nanoparticles are composed of compositions of the formula [MO]_{0.y}.[Al₂O₃]_{1.0-y} where M is selected from the group consisting of group IA elements, group IIA elements, group IIIA elements, transition metals, lanthanide metal, actinide metals, group IIIB elements, group IVA elements, and group VA elements, and y is a number from 0 to 1. As non-limiting examples, the nanopowder can includes nanoparticles of Li_{6.25}Al_{0.25}La₃Zr₂O₁₂, LiMn₂O₄, Li₂B₄O₇, Al₂O₃, Y₂O₃, ZrO₂, NiAl₂O₄, NiO, Fe₂O₃, HfO₂, SiO₂, RE₂O₃ (Rare earth, lanthanide, actinide) and combinations thereof. The nanopowder can be made by liquid-feed flame spray pyrolysis (LF-FSP), co-precipitation, or sol-gel synthesis. However, LF-FSP consistently generates nanopowders that are suitable for generating thin films. Although not shown in FIG. 1, in some aspects of the current technology, the method 10 comprises generating the nanopowder by LF-FSP. Nanopowder generation by LF-FSP is described in further detail below.

In various embodiments, the nanopowder suspension includes a dopant. The dopant can be a second nanopowder, i.e., a doping nanopowder, or a doping material (also referred to as a “doping element”). The dopant can also be a plurality of dopants. Doping results, as non-limiting examples, in the addition of Al³⁺, Ga³⁺, In³⁺, Mn²⁺, Ca²⁺, Ba²⁺, Sr²⁺, Y³⁺, Nb⁵⁺, Ta⁵⁺, Si⁴⁺, Mo⁵⁺, RE³⁺ rare earth, actinides, lanthanides, or combinations thereof into the thin film.

The solvent can be any solvent that suspends the nanopowder. Therefore, the solvent does not solubilize the nanopowder. Non-limiting examples of suitable solvents include water, methanol, ethanol, propanol, butanol, xylene, hexane, methyl ethyl ketone, acetone, toluene, or combinations thereof. When the solvent includes two components, such as, for example, ethanol and xylene, ethanol and methyl ethyl ketone, ethanol and acetone, or ethanol and toluene, the two components are present at a ratio of from about 10:90 to about 90:10, or from about 30:70 to about 70:30. However, it is understood that the solvent can include one, two, or more than two components.

The additive components include at least one of a dispersant, a binder, and a plasticizer. However, it is understood that the nanopowder suspension can contain at least one dispersant, at least one binder, and/or at least one plasticizer.

The dispersant is soluble in the solvent and lowers the viscosity of the suspension. Non-limiting examples of suitable dispersants include polyacrylic acid, bicine, citric acid, steric acid, fish oil, phenylphosphonic acid, phosphoric acid, ammonium polymethacrylate, organosilanes, and combinations thereof. When present, the dispersant has a concentration in the nanopowder suspension of greater than or equal to about 0.1 wt. % to less than or equal to about 5 wt. % or greater than or equal to about 1 wt. % to less than or equal to about 3 wt. %.

In some aspects of the current technology, the dispersant is added at the time the nanopowder is combined with the binder and plasticizer. In other aspects, the dispersant is associated with the nanopowder when the nanopowder is combined with the binder and plasticizer. For example, the nanopowder can be washed prior to being combined with a solvent. Washing the nanopowder includes suspending the nanopowder in a solvent that comprises a dispersant to generate a primary suspension. The solvent is a solvent or mixture of solvents described above. The primary suspension is mixed, such as, for example, by ball milling, and the primary suspension is then settled for greater than or equal to about 30 minutes to less than or equal to about 30 hours (or longer). Settling causes larger powders and impurities, if any, to settle and for the solvent to generate a supernatant. After the settling, the supernatant is removed, for example, by decanting, and the resulting washed nanopowder is dried at ambient temperature or a temperature of greater than or equal to about 20° C. to less than or equal to about 100° C. in ambient air, in an environment comprising an inert gas, such as, for example, nitrogen, helium, neon, argon, or xenon, or under vacuum. The dried nanopowder remains associated with the dispersant.

The binder is provided to bind the nanoparticles together. Non-limiting examples of suitable binders include polyvinyl butyral, polyvinyl acetate, methyl cellulose, ethyl cellulose, polyacrylate esters, polyurethane, polyethylene glycol, acrylic compounds, polystyrene, polyvinyl alcohol, polymethylmethacrylate, polybutylmethacrylate, and combinations thereof. When present, the binder has a concentration in the nanopowder suspension of greater than or equal to about 30 wt. % to less than or equal to about 50 wt. % or greater than or equal to about 35 wt. % to less than or equal to about 45 wt. %.

The plasticizer is added to promote plasticity and flexibility. Non-limiting examples of plasticizers include benzyl butyl phthalate, acetic acid alkyl esters, bis[2-(2-butoxyethoxy)ethyl] adipate, 1,2-Dibromo-4,5-bis(octyloxy)benzene, dibutyl adipate, dibutyl itaconate, dibutyl sebacate, dicyclohexyl phthalate, diethyl adipate, diethyl azelate, di(ethylene glycol) dibenzoiate, diethyl sebacate, diethyl succinate, diheptyl phthalate, diisobutyl adipate, diisobutyl fumarate, diisobutyl phthalate, diisodecyl adipate, diisononyl phthalate, dimethyl adipate, dimethyl azelate, dimethyl phthalate, dimethyl sebacate, dioctyl terephthalate, diphenyl phthalate, di(propylene glycol) dibenzoate, dipropyl phthalate, ethyl 4-acetylbutyrate, 2-(2-ethylhexyloxy)ethanol, isodecyl benzoate, isooctyl tallate, neopentyl glycol dimethylsulfate, 2-nitrophenyl octyl ether, poly(ethylene glycol) bis(2-ethylhexanoate), poly(ethylene glycol) dibenzoate, poly(ethylene glycol) dioleate, poly(ethylene glycol) monolaurate, poly(ethylene glycol) monooleate, poly(ethylene glycol) monooleate, sucrose benzoate, 2,2,4-trimethyl-1,3-pentanediol dibenzoate, trioctyl timelitate, and combinations thereof. When present, the plasticizer has a concentration in the nanopowder suspension of greater than or equal to about 30 wt. % to less than or equal to about 50 wt. % or greater than or equal to about 35 wt. % to less than or equal to about 45 wt. %.

Referring back to FIG. 1, in block 14 the method 10 comprises ball milling the nanopowder suspension to generate a milled nanopowder suspension. Ball milling is performed in a sealed container containing milling media. In various aspects of the current technology, the milling media is composed of a material that is present in the nanopowder. Non-limiting examples of milling media, which are chosen depending on the nanopowder being milled, include ZrO₂, Al₂O₃, SiC, Y:ZrO₂, agate, and combinations thereof. Ball milling is performed for a time of greater than or equal to about 0.5 hours to less than or equal to about 72 hours, greater than or equal to about 6 hours to less than or equal to about 48 hours, or greater than or equal to about 12 hours to less than or equal to about 24 hours.

After ball milling, in block 16 the method 10 comprises casting a layer of the milled nanopowder suspension on a substrate. The casting includes disposing or applying the milled nanopowder suspension directly onto a substrate to form a layer, wherein the layer comprises the milled nanopowder suspension. The casting can be performed by any method known in the art, such as for example, by bar coating, wire wound rod coating, drop casting, spin coating, doctor blading, dip coating, or spray coating. However, bar coating and wire wound rod coating provide thin layers with consistent thicknesses. The layers can have, for example, a thickness of greater than or equal to about 1 μm to less than or equal to about 500 μm, greater than or equal to about 1 μm to less than or equal to about 400 μm, greater than or equal to about 1 μm to less than or equal to about 300 μm, greater than or equal to about 1 μm to less than or equal to about 200 μm, or greater than or equal to about 1 μm to less than or equal to about 100 μm.

The substrate material is limited only by the intended use of the thin film. In some embodiments, the substrate can be composed of any material from which the layer can be removed. Put another way, the substrate cannot be composed of a material that sticks to the layer to such an extent that (after drying as described below) the layer cannot be removed from the substrate without damaging the layer. In other embodiments, the thin film is permanently bound to the substrate. For example, the substrate can be a thin material, which along with the thin film, form a bilayer. As non-limiting examples, the substrate can be composed of polyethylene terephthalate (PET; “polyester”), biaxially-oriented polyethylene terephthalate (BoPET, also known as MYLAR®), polytetrafluoroethylene (PTFE, also known as TEFLON®), plastics, including polystyrene, polyvinyl chloride, nylon, poly(methyl methacrylate), rubber, metal, steel, stainless steel, thin sheets of metal or steel (such as a foil), and glass.

In block 18, the method 10 comprises drying the layer. The drying is performed by incubating the layer at ambient temperature or room temperature, or a temperature of greater than or equal to about 20° C. to less than or equal to about 200° C. Incubating is performed for a time of greater than or equal to about 30 minutes to less than or equal to about 24 hours, or greater than or equal to about 2 hours to less than or equal to about 10 hours. The drying rate can be controlled by providing a solvent rich atmosphere. The drying removes at least a portion of the solvent and results in a dried nanopowder/polymer composite layer, also referred to herein as a “green film.” In some embodiments, the drying removes all or substantially all, i.e., at least about 90%, at least about 95%, at least about 98%, or at least about 99%, of the solvent to form the green film.

In block 20, the method 10 comprises removing the green film from the substrate. However, it is understood that that removing the green film from the substrate is optional. For example, when the substrate is to become a layer of a bilayer, then substrate is not removed. Removing can be performed by any method that does not damage the green film. For example, the removing can be performed manually (i.e., by hand), by using a prying object, or by using a gripping object, such as forceps. After it has been removed from the substrate, the dried layer (or bilayer when the substrate is not removed) can optionally be cut into any predetermined or desired shape and size. Cutting can be performed by any method, such as, for example, by using a die, a stamp, a scissors, a patterned silhouette, or a knife.

In block 22, the method 10 comprises compressing the green film to form a compressed green film. In some embodiments, the compressing is performed with heat, i.e., by thermo-compressing. Compressing is performed, for example, by compressing between dies, flat platens (such as with a straight press), or calendars (such as with a roll press) at a temperature of greater than or equal to about 20° C. to less than or equal to about 250° C., or greater than or equal to about 50° C. to less than or equal to about 200° C. Compressing or thermo-compressing removes pores and aligns polymer molecules. In some embodiments, the compressing is optional.

In block 24, the method 10 includes debindering (binder burnout) the dried nanopowder/polymer composite layer (the green film). When the method includes compressing, the debindering can be performed before or after the compressing. Nonetheless, it is preferred that debindering is performed after compressing. Debindering is performed by subjecting the green film to a temperature of greater than or equal to about 300° C. to less than or equal to about 700° C. for a time of greater than or equal to about 0.25 hours to less than or equal to about 10 hours. Debindering burns out the additive components to yield a debindered film.

In block 26, the method 10 comprises sintering the debindered film, to densify and form the film, i.e., a film. Sintering comprises heating the debindered film to a temperature of greater than or equal to about 700° C. to less than or equal to about 1700° C. for a time of greater than or equal to about 1 hour to less than or equal to about 48 hours. In various aspects, the sintering is performed in a controlled environment, such as an environment comprising an inert gas (e.g., nitrogen, helium, neon, argon, and xenon), CO₂, or a combination thereof. The sintered thin film has a thickness of greater than or equal to about 1 μm to less than or equal to about 500 μm and an average grain size of less than or equal to about 15 μm, less than or equal to about 10 μm, less than or equal to about 7.5 μm, less than or equal to about 5 μm, less than or equal to about 2.5 μm, less than or equal to about 2 μm, less than or equal to about 1 μm, or less than or equal to about 0.1 μm.

The method 10 can also be formed to generate a multilayered thin film. Therefore, in various embodiments, the thin film is a multilayered thin film. For example, a first green film can be disposed onto a second green film before or after the second green film is removed from the substrate. At least one of the first and second green films can optionally be compressed. In some embodiments, the first and second green films are compressed at the same time, i.e., they are co-compressed. Moreover, the first and second green films can be composed of the same or different nanopowder including or not including a dopant. Additional green films can be added in a predetermined order, such as in an alternating order. The stacked green films are then optionally co-compressed and co-sintered to generate a composite thin film. In some aspects, a first dried film is disposed onto a second dried film, wherein one of the first or second dried films has previously been sintered.

In some embodiments, the nanopowder suspension includes a rare earth element dopant and the method 10 generates a ceramic thin film doped with the rare earth element. Prior to sintering, a green or debindered ceramic thin film doped with the rare earth element is disposed onto a metal material, such as a metal foil, or a green metal film made according to the current technology, to form a bilayer. Alternatively, the green or debindered ceramic thin film doped with the rare earth element is permanently made on a metal substrate (such as a metal foil) as a bilayer, i.e., there is no removing. If green, the ceramic thin film doped with the rare earth element is debindered. The bilayer is then sintered after optionally being thermo-compressed. The result is a composite bilayer thin film having a ceramic side (doped with the rare earth element) and an opposing metal side. By way of the metal side, the composite bilayer thin film can be disposed onto a material that conducts heat, such as metal, steel, or a thermally conductive polymer. When heat is transferred through the metal side of the composite bilayer thin film to the ceramic side (doped with the rare earth element), the ceramic side emits light as thermo-luminescence. Accordingly, various aspects of the current technology provide composite thin films that thermo-luminesce when heated.

The current technology also provides thin films, including composite multilayered thin films, made according to the method 10 of FIG. 1.

Various aspects and embodiments of the above method are now further described.

Casting is a process in which a suspension of well dispersed particles of oxides, carbides, or nitrides in a selected aqueous or non-aqueous solvent containing additives such as binders, plasticizers and dispersants, is spread onto a substrate at a fixed thickness to provide thin films or sheets, several microns to several hundred microns thick, of powder filled polymer composites. It is crucial to formulate a homogeneous suspension by carefully selecting compatible ingredients that stabilize the suspension over an extended period of time such that particles remain well dispersed during the casting and drying processes.

MYLAR biaxially-oriented polyethylene terephthalate is typically used as a substrate film, but any common flexible commercial polymer or metal film can be used as long as it is compatible with the formulated suspension such that it does not react or hinder the uniform spreading of the suspension.

The cast green films can be rolled and stored for later use or for use in roll-to-roll processing of laminates or cut to desired shapes and thermo-compressed between dies especially in continuous processes or flat platens heated at typical temperatures of 50°-200° C. to remove pores and align polymer molecules especially using axial or biaxial calendaring of the green film. Based on the polymer volume fraction and polymer molecular weight and entanglement, the green films may or may not spread during pressing/calendaring; however, there will always be a reduction in thickness on compression. In instances where only high volume fraction polymer green films can be obtained due to constraints during suspension formulations, pressing/calendering may prevent spreading during further processing.

Rolled or cut green films can also be used to construct materials with discrete alternating layers of selected compositions by compressing two or more different green films.

The green body can then be subjected to an oxidizing binder burnout at 300°-700° C. to remove residual solvent, binder, plasticizer, and dispersant. Debindered films can also be laminated with polymer films for example containing materials that limit interfacial diffusion and or subsequently sintered at 700°-1700° C. to produce target characteristic phases and densities, either fully dense or porous. They can also be treated in reducing atmospheres to transform one or more component to the metal or metal nitride depending on conditions.

Compared to conventional casting, in which submicron to micron particle feedstocks are used, the invention uses flame made nanoparticles as described in the prior art, particles with sub-100 nm diameters. Nanoparticles have very high surface area to volume ratios resulting in a large fraction of atoms residing at or near the surface of the powder, which are in higher energy compared to the bulk material. Hence, nanoparticles are known to have lower sintering temperature compared to sub-micron or micron particles, meaning full density can be reached at lower temperatures and with finer grain sizes on densification. Also, smaller grain sizes, below 3 μm but preferably below 500 nm, can be obtained by controlling sintering atmospheres or temperatures to modify microstructural evolution imparting higher mechanical strength compared to larger grained materials (>5 μm) obtained when processing sub-micron or micron particles.

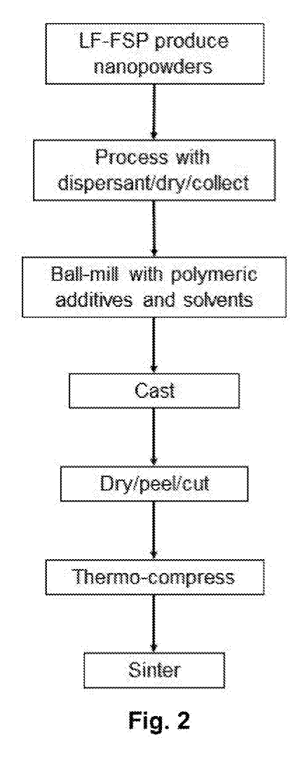

An exemplary method for preparing a film according to various aspects of the current technology is shown in FIG. 2. Nanoparticles that can be used for the invention can be made by but are not limited to flame spray pyrolysis, co-precipitation, and sol-gel synthesis. However, it is preferred to start with liquid-feed flame spray pyrolysis made nanoparticles as they are very often spherical and have log normal size distributions that improve the packing density of green films which in turn results in lower sintering temperature and allows minimization of residual porosity where so desired. Liquid-feed flame spray pyrolysis (LF-FSP) offers the added benefit of scalability such that any developed process can be relatively easily transformed to industrial scale. Also, the selection of starting materials for green film formulation is easier as similar chemicals can be used for processing a wide range of nanopowders with different compositions.

The suspension preferably contains a dispersant to lower the viscosity of the mix, either functioning by electrostatic or electrosteric hindrance. Suitable dispersants may be soluble in the selected solvent system. Examples include but are not limited to polyacrylic acid, bicine, citric acid, steric acid, fish oil, and phosphoric acid. Dispersants may be anchored (chemically bonded) to the surface hydroxyl of the powders before suspension formulation, or may be simply added at selected wt. %, preferably 1-3 wt. %, during suspension formulation. The suspension preferably contains a solvent or a mixture of solvents, either aqueous or non-aqueous to impart low viscosity to the final mix. Suitable solvent systems will disperse the powders easily in the presence of a dispersant. Examples include but are not limited to mixtures of ethanol/xylene, ethanol/methyl ethyl ketone, ethanol/acetone, and ethanol/toluene. The volume ratio of solvents can range from 10/90-90/10 but preferably 30/70-70/30.

The suspension preferably contains a binder that provides mechanical or green strength to the formed powder/polymer composite after solvent removal. Examples include but are not limited to polyvinyl butyral and polyethylene glycol. The binder should be soluble in the selected solvent system and should not hinder dispersion of the powder.

The suspension preferably contains a plasticizer, which alters the plasticity of the binder or the resulting green film. Examples include but are not limited to benzyl butyl phthalate.

The suspension preferably has solids loadings of 40-60 vol. % (60-90 wt. %) but preferably 45-55 vol. % after solvent removal for easy handling as well as high enough green density to reach 90+% relative densities on sintering. Lower solids loading green films may be intentionally processed if very thin films or low density or high porosity final sintered films are of interest.

The formulated suspension is ball-milled for 6-48 h but preferably 12-24 h in a sealed container using ZrO₂, Al₂O₃, or SiC milling media. Any commercial milling media may be used as long as the milling media is composed in part of the elements comprising the processed material, to prevent any possible contamination.

The cast green film may be dried at room temperature or at elevated temperature of 40° to about 200° C. as long as it does not diminish green strength or powder dispersion during drying. It may also be air dried or dried in a solvent rich atmosphere to control evaporation rates to prevent formation of surface skins that may hinder evaporation of solvent from the bulk resulting in extended drying time and or film distortion or cracking. It is also possible to dry films in a reactive atmosphere such as CO₂ or partial CO₂ to produce some carbonate for use as a sintering aid.

The invention can be used to process oxide solid electrolyte thin films for all-solid state batteries or solid oxide fuel cell components. In particular, intensive efforts seek materials and battery configurations that offer performance superior to state-of-the-art (SOA) lithium batteries currently extant. Li₇La₃Zr₂O₁₂ (LLZO) based Li⁺ ion conductor ceramic oxides, in particular, have gained much attention due to its high electrochemical stability window (up to 6 V), stability in contact with lithium metal, and high ionic conductivities (10⁻⁴-10⁻³ S cm⁻¹ depending on doping elements), making it a good candidate to replace current liquid electrolytes which are the main cause of lithium ion batteries' catastrophic failure to date. Also, use of a lithium metal anode provides dramatic improvements in the energy densities of a given cell, which becomes possible by using LLZO as an electrolyte.

LLZO has mainly been produced in pellet forms in which powders produced by solid-state reaction, co-precipitation, or sol-gel synthesis are calcined, ball-milled, and subsequently sintered at 1100-1200° C. for 10-40 h covered in mother powder, to obtain >90% relative density samples. Another approach is to hot-press the powders at 1000-1100° C. for 1-4 h at 40-60 MPa to achieve high densities >95%.

All of these processes are energy intensive and neither has previously appeared to provide viable thin films (10-50 μm). A further issue is that such films are anticipated to have such large grain sizes that they will be too fragile to further process into solid-state batteries. In contrast, it has been anticipated that hot-pressing may provide access to thin films with good mechanical properties but the practical utility of such an approach for mass production of solid state batteries has yet to be proven economical and access to films 10-30 μm has not been demonstrated.

Other alternative processing routes to films include aerosol deposition, sol-gel dip coating, or pulsed later deposition where film thicknesses range from several hundred nanometers to 10's of microns although they suffer from low ionic conductivities of 10⁻⁸-10⁻⁶ S cm⁻¹. Scalability for films 10-20 μm is also questionable.

To date, no one has succeeded in producing dense LLZO (>90% of theory) thin (10-30 μm thick) mechanically strong films with ionic conductivities equivalent to bulk (pellet, >10⁻⁴ cm⁻¹) counterparts.

In one embodiment, ceramic thin films of Li₇La₃Zr₂O₁₂ (LLZO) doped with selected elements are processed. The Li site can be partially replaced with Al³⁺, Ga³⁺,Mg²⁺, or mixtures of such. The La site can be partially replaced with Ca²⁺, Ba²⁺, Sr²⁺, Y³⁺, Sc³⁺, or mixtures of such. The Zr site can be partially replaced with Nb⁵⁺, Ta⁵⁺, or mixtures thereof. Multiple doping elements can replace two or three sites at a time to give optimal sintering behavior and electrochemical properties. The doping elements may be introduced in the precursor solution as a metalloorganic precursor such that as-produced powders are doped with the selected elements. The doping elements may also be introduced by means of solid-state reaction in which dopant nanopowders are separately produced by flame spray pyrolysis process and introduced during suspension formulation.

The invention may be used to produce cathode thin films for lithium ion battery application. There is a drive to process thin films of lithium ion battery cathode materials at lower sintering temperatures to minimize inter-diffusion when adjoining with the electrolyte layer.

In one embodiment, lithium battery cathode thin films are processed. As an example, thin films of LiMn₂O₄ were processed where Mn sites may be replaced with selected doping elements to improve cycle-ability and/or capacity. Dopants can be introduced in the same manner as described in doping of LLZO.

Inter-diffusion of atoms from initially discrete layers on heating to elevated temperature (>700° C.) results in by-products that are physical barriers that block Li⁺ conduction. Hence, it is ideal to place an intermediate layer that blocks inter-diffusion, readily bonds to both electrolyte and cathode layer, and gradually gets absorbed to either electrolyte and/or the cathode layer on heating. Thickness of the intermediate layer and heating schedule may be adjusted to control the kinetics of intermediate layer being absorbed to either electrolyte of cathode layer. Examples of suitable intermediate layer materials include but are not limited to the binary or ternary compounds in the Li₂O—B₂O₃, Li₂O—SiO₂, Li₂O—P₂O₅, Li₂O—B₂O₃—SiO₂, Li₂O—B₂O₃—P₂O₅, and Li₂O—SiO₂—P₂O₅ systems.

A further example of an intermediate layer that could be used as a polymer precursor to LiPON could be produced from reaction of POCl₃ as illustrated in the following equations which are meant to be instructive rather than limiting.

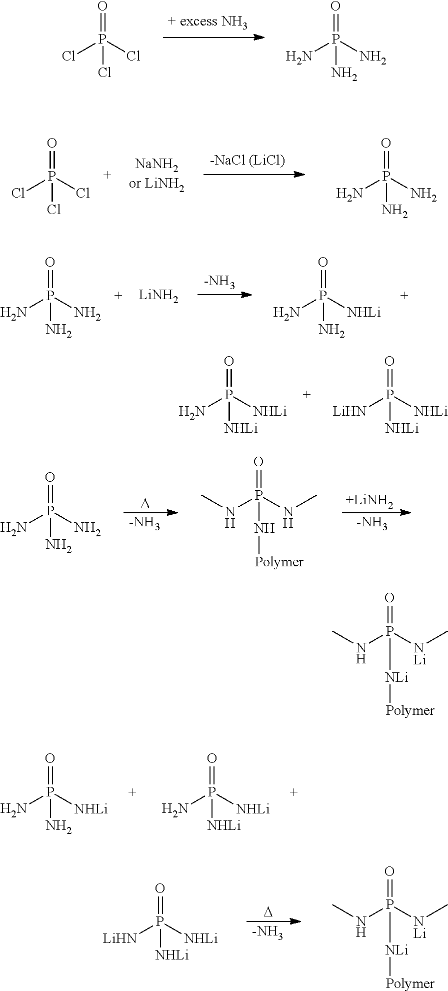

An approach that avoids the first step in the above scheme follows. In particular, synthetic pathways to LiPON and LiSiPON polymer precursors are provided. The reaction proceeds easily at ambient but at least two products form, a liquid and a white solid. Both products are reactive with LiNH₂.

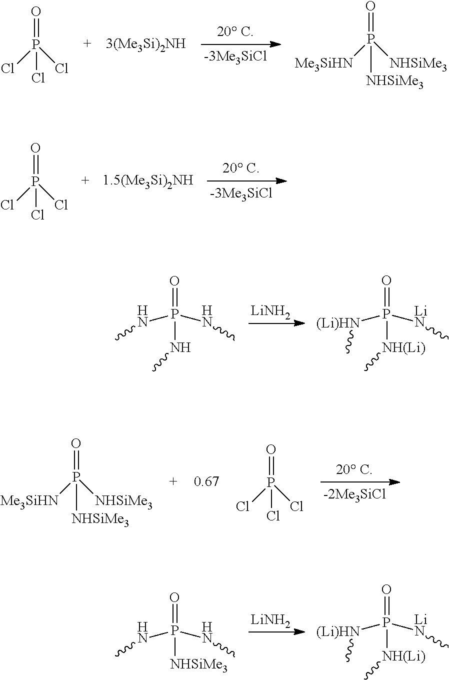

With the exception of purely interface coatings, such as for LiPON materials, they may also be mixed with LLZO at 1-10 wt. % to aid densification. Nanopowders of such can be produced by LF-FSP and processed to green films as described above. The intermediate green films with thicknesses of 1-5 micron may be bonded to the cathode green film by thermo-compressing at pressures of 1-10 ksi for 1-60 min at 35°-170° C. The dual layer laminate green film is then subjected to binder burn-out and placed on a sintered LLZO film and sintered at temperatures high enough to bond the dual layer laminate film onto the LLZO film while minimizing inter-diffusion such that final microstructure is a tri-layer of cathode/intermediate/solid electrolyte or bi-layer of cathode/solid electrolyte if intermediate layer is completely absorbed.

The invention may be used to produce ceramics with sharp edges which may be used for cutting. Ceramic knives, or ceramic razor blades may be produced by pre-shaping the green film by cutting diagonally to grant sharp edges. Selected LF-FSP produced nanopowders result in micron to submicron grain sizes on sintering which endow unprecedented high mechanical strength which can be further enhanced by selecting materials with self-toughening mechanisms such as ZrO₂—Al₂O₃ as detailed in prior art.

The process of this invention may be used to produce ceramic-metal (cermet) composites. Composites of ceramic and metal are of interest due to high fracture toughness and high impact strength which are useful for structural applications. The ceramic and metal may be intermixed to grant isotropic properties, or it may be discrete alternating layers to control the mechanical properties to be anisotropic. Metal used here are derived by reducing liquid feed-flame spray pyrolysis synthesized oxide nanopowder in flowing hydrogen, meaning any metal oxide that easily reduces in the presence of hydrogen can be used as long as it is thermodynamically stable when in contact with the oxide of interest.

In one embodiment, lamellar metal-ceramic composites having alternating discrete layers are processed. The ceramics can be but are not limited to Al₂O₃, Y₃Al₅O₁₂, and Y:ZrO₂ or composites of such with high mechanical properties. The metals can be derived from easily reduced metal oxides in the presence of H₂ including but not limited to Ni, Cu, Fe, W, Ti, Co, Mo, Bi, or alloys of such. There can be more than one type of material of each component alternating such that it is a composite that two or more type of oxides alternate and two or more type of metals alternate.

The process of this invention may be used to produce oxide composites in which more than one oxide are intermixed within the bulk of the film. Individual oxides may be produced and mixed at selected ratio during the suspension formulation, or metalloorganic precursors corresponding to the final composition may be dissolved in alcohol and combusted such that the as-produced powder has the final composition.

According to the principles of the present teachings, a nanopowder or nanopowder mixture of single or multiple metal oxides/carbonates/carbides/nitrides is mixed with a polymer binder and a solvent such that sufficient viscosity is achieved to permit forming a thin film using, for example, a doctor blade or wire wound roller coater. The nanopowders can consist of mixtures of group IA, IIA, IIIA, transition metal, lanthanide and/or actinide metals, group IIIB, IVA and VA elements or their oxides, phosphates, nitrides, carbides or combinations thereof. The polymer binder can be any polymer or mixture of polymers including for example polymethylmethacrylate, polybutylmethacrylate, polyacrylic acid, benzyl butyl phthalate, polyvinyl butyral where these examples are exemplary but not meant to be limiting and solvents including water, acetone, ethanol, propanol, ethylene glycol or other polar solvents including methylethyl ketone such that drying occurs sufficiently slowly to limit or eliminate cracking.

Thereafter, the film can be warm pressed or calendared especially with another film of another material or two more films of the same or different nanopowder/polymer composites, as needed, to form laminated green films. The second material can be a thin film of an interfacial precursor prior to adding a third film. The resulting films can then be heated or photochemically treated to further crosslink polymers or additives or both and thereafter heated to between 300° C. and 700° C. at heating rates that gently decompose the binder and additives in air, argon, nitrogen or other gas to control the rate of and mechanism of decomposition to ensure that the resulting films have sufficient mechanical strength to be further processed. The resulting debindered films can then be laminated with a second film, coated with a interfacial coating of a ceramic precursor or a ceramic powder to control or limit interfacial diffusion of undesirable ions or to dope the first layer or a second layer laminated above this middle layer with the goal of passivating the interface against degradative processes that can occur during further processing or when the multilayer ceramic is used in specific applications as exemplified by fuel cell or lithium or sodium or sulfur battery electrolyte; although these examples are not meant to be limiting.

Thereafter, the debindered film or laminate can be heated in a controlled atmosphere of for example nitrogen, argon, methane, air with or without up to 10 vol. % CO₂ and in the absence of air up to about 20 vol. % H₂ for example in nitrogen or in ammonia to aid in the densification of the thin films while also selectively converting one or more metal oxides to the metal and/or nitride or carbide while keeping other metal oxides intact during the densification process. In some instances excess of one oxide component in multiple chemical forms can be introduced at the outset as a sacrificial component that will be lost as for example P₂O₅ or B₂O₃ or Li₂O during processing such that the final composition is that targeted. As an alternative but less desirable, a coating of this type of sacrificial material may be added prior to sintering to minimize outgassing of the same component to ensure that the final stoichiometry is that targeted. It is also possible to add an interfacial coating at this stage prior to mating films or laminates to make thicker multilayer films while protecting against interdiffusion or to adhere one film to another. Sintering can be undertaken by heating samples at rates of 1° to 30° C./min to temperatures that promote densification while also minimizing loss of volatile components. In particular it is possible to heat rapidly to a temperature above the most desirable sintering temperature for a very short time to initiate formation of a liquid sintering aid and then rapidly cool to a lower temperature to continue densification where loss of volatile components are reduced or eliminated. It is also possible to heat under gas pressure to further promote densification if all open porosity has been eliminated.

In some embodiments, the nanopowder compositions consist of either single or multi-element oxide nanoparticles and mixtures thereof with the general composition AlxByPᵤLaₘLi_{z}NbₐSi_{b}Ta_{c}Zr_{d}YₑO_{f} where the molar range of each element can be: x=0.05 to 0.99, y=0.00 to 0.99, u=0.0 to 3.0, m=2.0-3.5, z=2.5-10.5, a=0.05 to 3.5, b=0.01 to 1.0, c=0.25 to 5.0, d=0.0-2.0, and e=0.01 to 0.5 but preferably x=0.2 to 0.3, y=0.0 to 0.3, u=0.0 to 0.3, m=2.0-3.0, z=6.5-10.5, a=0.0 to 0.3, b=0.0 to 0.3, c=0.0 to 0.3, d=1.0-2.0, and e=0.01 to 0.2

The choice of ratios is defined by the sintering conditions required to produce thin films of cubic LLZO with densities >90%, grain sizes less than about 10 μm and preferable less than 5 μm and most preferably smaller than about 3 μm where the films are less than about 50 μm thick and preferably less than 40 μm thick and most preferable less than about 20 μm thick but with sufficient mechanical properties to be layered into laminates or coated with polymer films or used in the production of all solid state batteries without undergoing brittle failure.

In some embodiments, the nanopowder compositions consist of either single or multi-element oxide nanoparticles and mixtures thereof with the general composition, AlᵤVᵥNi_{w}CoₓLi_{y}Mn_{z}NₐP_{b}Ti_{c}O_{d} where the molar range of each element can be: u=0.0 to 2.0, v=0.0 to 2.0, 2=0.0 to 2.0, x=0.0 to 2.0, y=0.0 to 5.0, z=0.0 to 3.0, a=0.0-2.0, b=0.0-3.0, and c=0.0 to 2.0.

In some embodiments, the nanopowder compositions consist of either single or multi-element oxide nanoparticles and mixtures thereof with the general composition, AlₓY_{y}Zr_{z}Oₐ where the molar range of each element can be: x=0.0 to 6.0, y=0.0 to 4.0, and z=0.0 to 3.0

Such that on sintering two or three phases are generated in the resulting thin film including alpha alumina and yttrium aluminum garnet and yttria stabilized zirconia.

In some embodiments, the nanopowder compositions consist of either single or multi-element oxide nanoparticles and mixtures thereof with the general composition, AlₓCo_{y}Ni_{z}YₐZr_{b}O_{c} where the molar range of each element can be: x=0.0 to 6.0, y=0.0 to 5.0, z=0.0 to 3.0, a=0.0-3.0, and b=0.0-3.0.

Such that on sintering two or three phases are generated in the resulting thin film including cobalt or nickel oxide or aluminate and yttrium aluminum garnet and yttria stabilized zirconia. If the films are heated in a hydrogen containing atmosphere then the resulting thin film can be porous and contain cobalt or nickel or cobalt-nickel alloy particles supported on porous but strong thin substrate of the dimensions that provide mechanical strength but also surface areas sufficient to promote good rates of catalytic reactions.

In some embodiments, the thin films are produced using wire wound roller coating and thereafter debindering and then sintering in a controlled atmosphere with a heating rate of less than 25° C./min and preferably less than 15° C./min such that the final grain sizes are preferably less than about 5 μm for 50 μm thick films and most preferable smaller than about 3 μm for 20 μm thick films and where any residual pores are less than 1 μm and preferably less than 0.5 μm in diameter.

In some embodiments, the thin films are heated on a substrate that is inert to the film being processed including zirconia, yttrium aluminum garnet, nickel metal, graphite and diamond like carbon where the atmosphere is non-oxidizing but can be reducing and where the sintering temperature is below the decomposition or melting temperature of the substrate.

In some embodiments, the sintering temperature can be as high as 1600 for 30 min and then held at 1080° C. for 1 h or more preferably to 1150° C./30 min and held at 1060 for 1 h and most preferably to 1100° C. for 20 min or less and then at 1080° C. for 1 h.

In some embodiments, rapid heating to temperatures between 850° C. and 1300° C., preferably between 950° C. and 1250° C., at ramp rates of 5 to 30° C./min, but preferable 10-20 and most preferable 10-15

In some embodiments, rapid heating in an atmosphere of O₂, synthetic air, Ar, N₂ in the presence of 0.01-25% CO₂ and more preferably between 0.01 and 15% and most preferably less than 8%.

Methods among those of the present technology are illustrated in the following non-limiting examples.

### Example 1—Dense Thin Films of Li₇La₃Zr₂O₁₂ (LLZO) Based Oxide Electrolytes

Nanopowders with nominal compositions of Li_{6.25}Al_{0.25}La₃Zr₂O₁₂ with varying excess lithium content, 10-50 wt. % but preferably 30-50 wt. %, were synthesized by LF-FSP process. Excess lithium is used to compensate for lithium loss during sintering process as LLZO readily loses Li₂O as vapor at temperature beyond 900° C.

Lithium propionate, alumatrane, lanthanum isobutyrate, zirconium isobutyrate at selected molar ratios were dissolved in ethanol at 1 to 10 wt. % but preferably at 1 to 3 wt. % and subsequently aerosolized and combusted in an oxidizing atmosphere using LF-FSP as detailed in prior art. Due to inherent instability of LLZO in the presence of H₂O and CO₂, combustion products are not single phase LLZO but a mixture of Li₂CO₃ and off-stoichiometric La₂Zr₂O₇ phase which can be perceived as complete decomposition of LLZO.

The synthesized nanopowders were dispersed in ethanol with 1 to 8 wt. % of polyacrylic acid dispersant using an ultrasonic horn or ball-milling. After 4-10 h of settling, supernatant was decanted and dried at 50-90° C. until all solvent was removed. The cleaned nanopowders were ball-milled with binder B-98 (polyvinylbutyral), plasticizer (benzyl butyl phthalate), and solvent (ethanol/acetone mixture) at a selected ratio using 3.0 mm ZrO₂ milling media. Typical mixing ratio of nanopowder, binder, plasticizer, solvent was 30-40:3-6:3-6:50-60 by weight. Ethanol to acetone ratio can be modified between 10:90 to 90:10 but preferably between 30:70 and 70:30.

After 12 to 48 h of ball-milling process to homogenize the suspension, it was cast onto a MYLAR® film via wire wound rod coating or bar coating. After 2 to 10 h of drying process, films were peeled off from MYLAR® substrate and cut into controlled dimensions. Green films were thermo-compressed at pressures of 1-50 ksi but preferably 2-10 and most preferably 5-10 ksi for 5-60 min, preferably for longer than 5 min to maximize green densities.

The resulting green films were 20-50 μm based on suspension formulation and gap distance between the wire wound rod and the substrate. While films were pressed between dies in the current example, roll pressing or calendaring represents a simple option to permit continuous processing.

The resulting green films were placed then heated to between 1000° to 1150° C. at 5-15° C. min⁻¹ in flowing nitrogen or argon with less than 1% CO₂ and held for 0 to 5 h but preferably less than 5 h. The apparent density of the resulting 25 μm thick films was >90%. Extended heating results in formation of secondary phase La₂Zr₂O₇ and/or La₂O₃ due to Li₂O evaporation. Films sintered using appropriate heating schedules resulted in single phase, cubic LLZO as seen by XRD. Optimal sintering schedules depend on excess lithium content and film thicknesses.

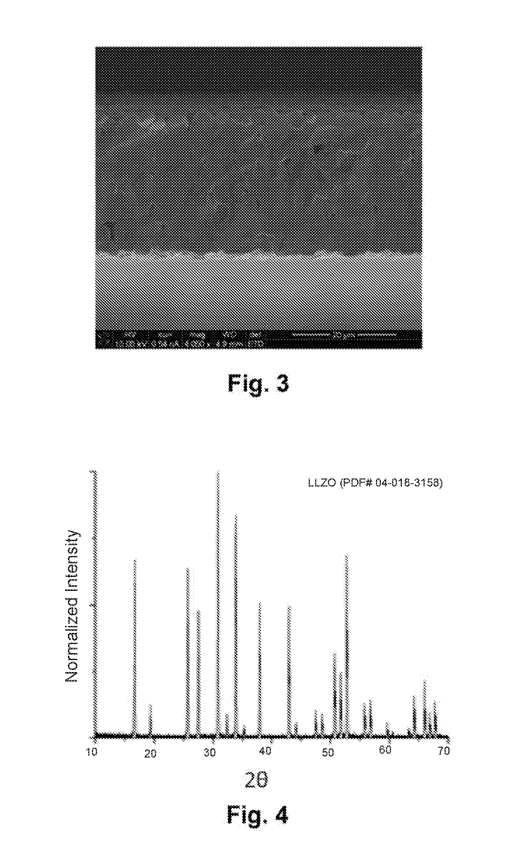

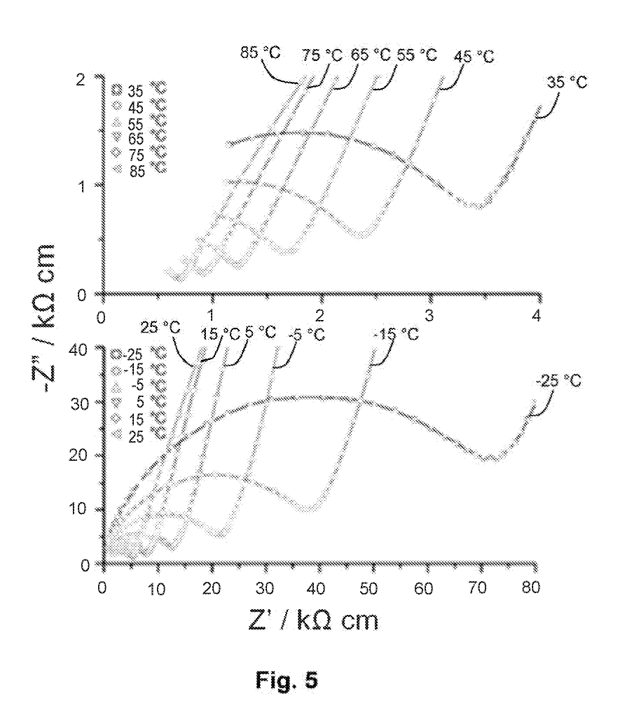

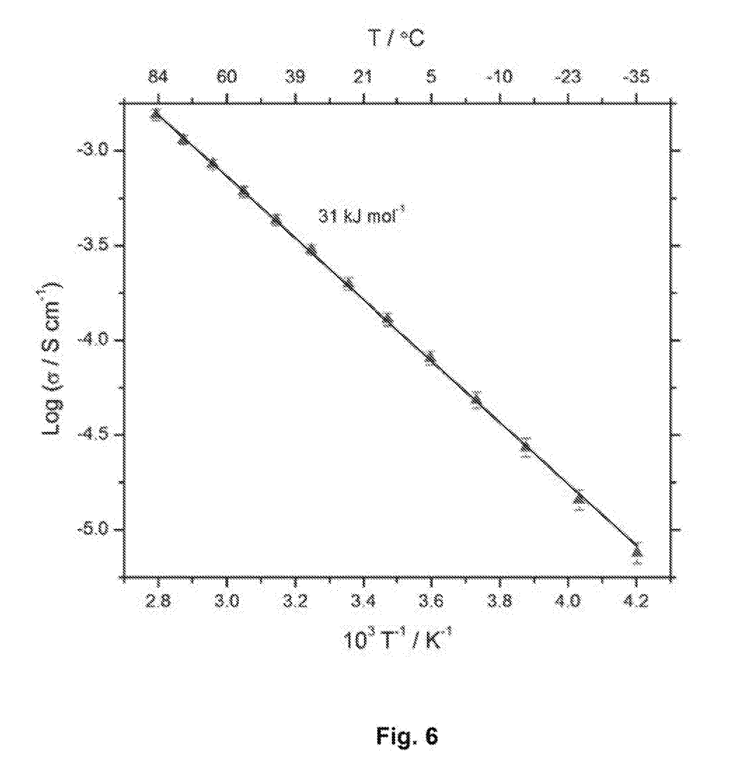

FIG. 3 shows a scanning electron microscopy (SEM) fracture surface image of a sintered LLZO film. FIG. 4 shows an x-ray diffraction (XRD) spectrum of the sintered LLZO film. FIG. 5 shows Nyquist plots of sintered LLZO film and FIG. 6 is a graph showing the temperature dependence of ionic conductivities. Room temperature ionic conductivities were measured by sputter coating gold electrodes on both sides of the film, and ranged from 0.1-0.4 mS cm⁻¹ based on sintering conditions. Ionic conductivities of 0.008±0.001 to 1.5±0.1 mS cm⁻¹ were measured at −35 to 85° C. with corresponding activation energy of 31±0.7 kJ mol⁻¹ (0.32±0.01 eV).

### Example 2—Dense Thin Films of LLZO with MgO Additions

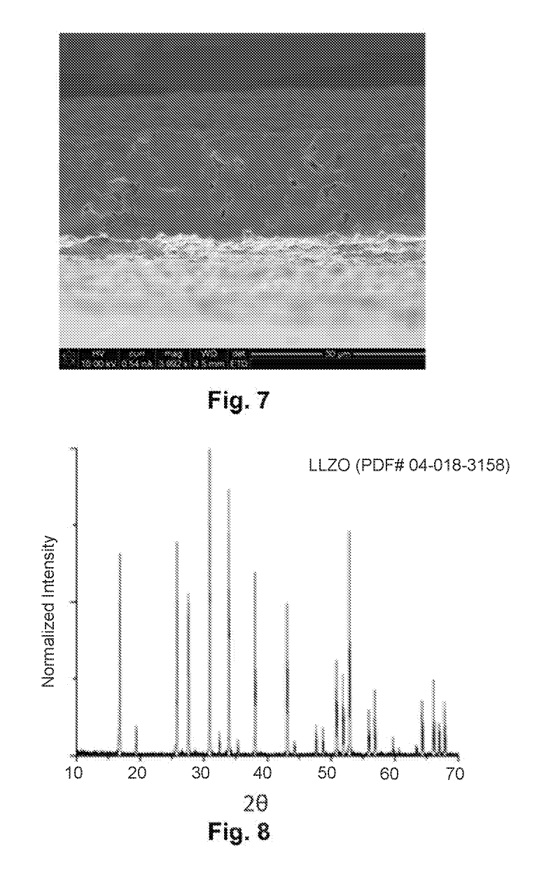

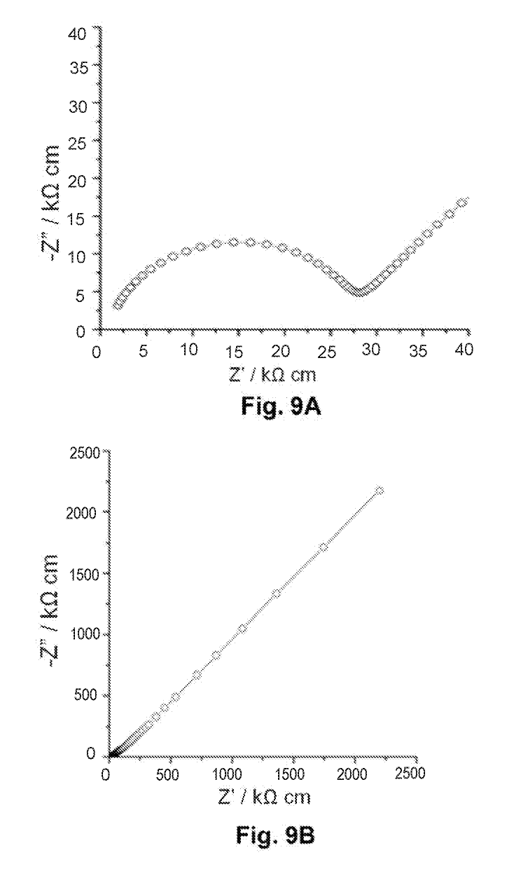

During suspension formulation described in Example 1, 0.25-1 wt. % of MgO was introduced by adding a corresponding amount of magnesium acetate tetrahydrate. Further processing followed the steps as detailed in Example 1. The motivation for MgO addition was to pin the grain growth given MgO is argued to be unreactive with LLZO. However, grain conductivities drop by ten-fold compared to MgO free samples, suggesting Mg doping Li sites. FIG. 7 shows a SEM fracture surface image of the resulting sintered LLZO-Mg film and FIG. 8 shows an XRD spectrum of the LLZO-Mg film. FIGS. 9A and 9B show Nyquist plots of the sintered LLZO-Mg film.

### Example 3—Dense Thin Films of Ta⁵⁺ Doped LLZO

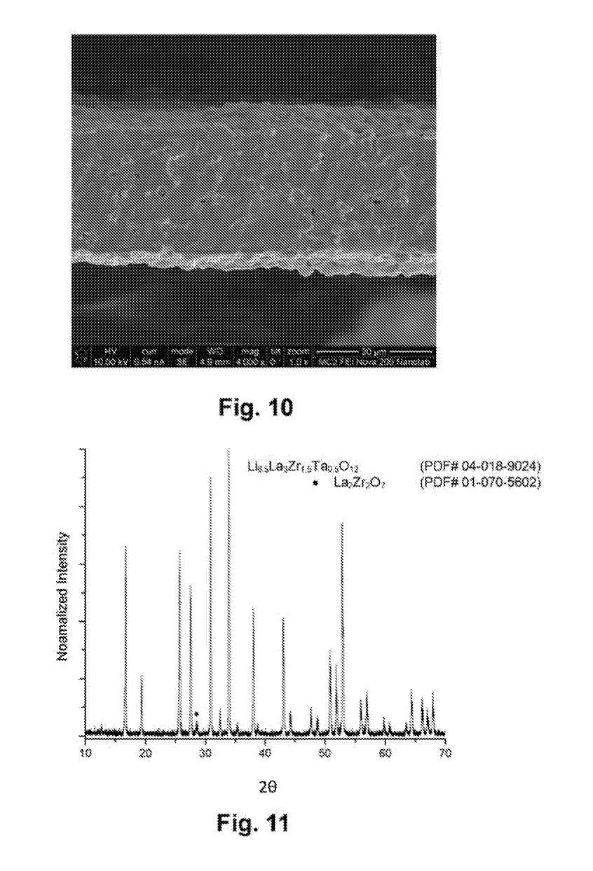

Nanopowders with nominal compositions of Li_{6.5}La₃Zr_{1.5}Ta_{0.5}O₁₂ with varying excess lithium content, 10-50 wt. % but preferably 30-50 wt. %, were synthesized by LF-FSP process. Tantalum-atrane was used as the Tantalum precursor. The produced nanopowders were processed to thin films as detailed in Example 1. FIG. 10 shows a SEM fracture surface image of the resulting Li_{6.5}La₃Zr_{1.5}Ta_{0.5}O₁₂—La₂Zr₂O₇ sintered film and FIG. 11 shows an XRD spectrum of the Li_{6.5}La₃Zr_{1.5}Ta_{0.5}O₁₂—La₂Zr₂O₇ sintered film.

### Example 4—Sintered LiMn₂O₄—Li₂B₄O₇ Film

Nanopowders in nominal compositions of LiMn₂O₄ and Li₂B₄O₇ were synthesized by LF-FSP. Lithium propionate, manganese acetate tetrahydrate, boric acid at selected molar ratio were dissolved in ethanol at 1 to 5 wt. % but preferably at 1 to 3 wt. % and subsequently aerosolized and combusted in an oxidizing atmosphere using LF-FSP as detailed in prior art.

The synthesized LiMn₂O₄ and Li₂B₄O₇ nanopowders were dispersed in ethanol with 1 to 3 wt. % of poly acrylic acid dispersant using an ultrasonic horn or ball-milling. After 4 to 10 h of settling, supernatant with dispersed powder was decanted, solvent removed and the recovered powders dried at 50° to 70° C. until all solvent was removed. The isolated nanopowders were ball-milled with polymeric additives to form a suspension as described in Example 1. Typical mixing ratios of nanopowder, binder, plasticizer, solvent were approximately 20-30:3-6:3-6:65-75 by weight. Amongst the fraction of nanopowder, 5 wt. % of Li₂B₄O₇ with respect to LiMn₂O₄ was used as a sintering aid. Ethanol/methyl ethyl ketone mixture was used as a solvent in which the ratio can be modified between 10:90 to 90:10 but preferably between 30:70 and 70:30.

The resulting suspension was cast, cut, and thermo-compressed using methods similar to that detailed in Example 1.

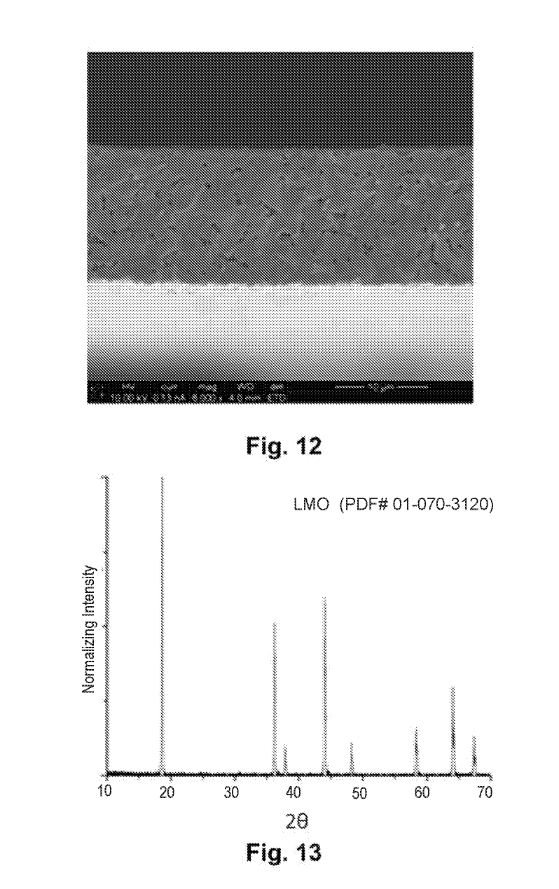

Thermo-compressed green films were heated to 750° C. at 5-15° C. min⁻¹ in flowing synthetic air and held for 3 to 10 h. The densities of the resulting 10-30 μm thick films were >90%. FIG. 12 shows a SEM fracture surface image of the resulting sintered LiMn₂O₄—Li₂B₄O₇ film and FIG. 13 shows an XRD spectrum of the sintered LiMn₂O₄—Li₂B₄O₇ film.

### Example 5—Lamellar Composites of Lithium Battery Cathode/Intermediate/Electrolyte (LiMn₂O₄—Li₂B₄O₇/Li₂B₄O₇/LLZO) Layers

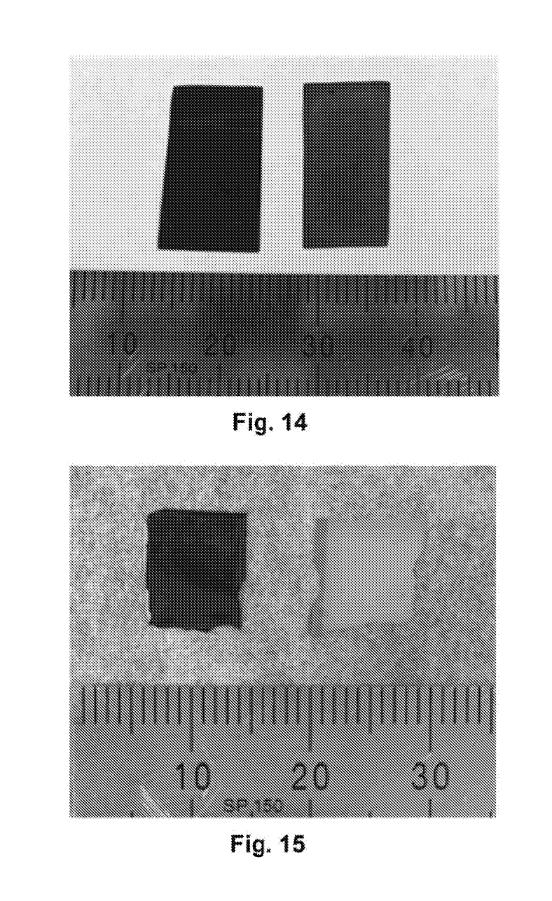

Li₂B₄O₇ synthesized as described in Example 3 were processed to green films and thermo-compressed onto LiMn₂O₄—Li₂B₄O₇ green film. The compressed lamellar composite was placed on sintered LLZO and heated to 500-700° C. for 1-10 h to result in tri-layered half-cell. FIG. 14 shows a green LiMn₂O₄—Li₂B₄O₇ film before lamination (left) and after lamination of Li₂B₄O₇ green film (right). FIG. 15 shows debindered LiMn₂O₄—Li₂B₄O₇/Li₂B₄O₇ lamellar composite films. The film on the left shows the LiMn₂O₄—Li₂B₄O₇ side and the film on the right shows the Li₂B₄O₇ coated side. The color difference is indicative of separate phases.

### Example 6—Sintered Al₂O₃—Y₃Al₅O₁₂ Oxide Composite Films

Nanopowders in nominal compositions Al₂O₃ and Y₂O₃ were synthesized by LF-FSP. Alumatrane and yttrium propionate were dissolved in ethanol at 1 to 5 wt. % but preferably at 1 to 3 wt. % and subsequently aerosolized and combusted in an oxidizing atmosphere using LF-FSP as detailed in prior art.

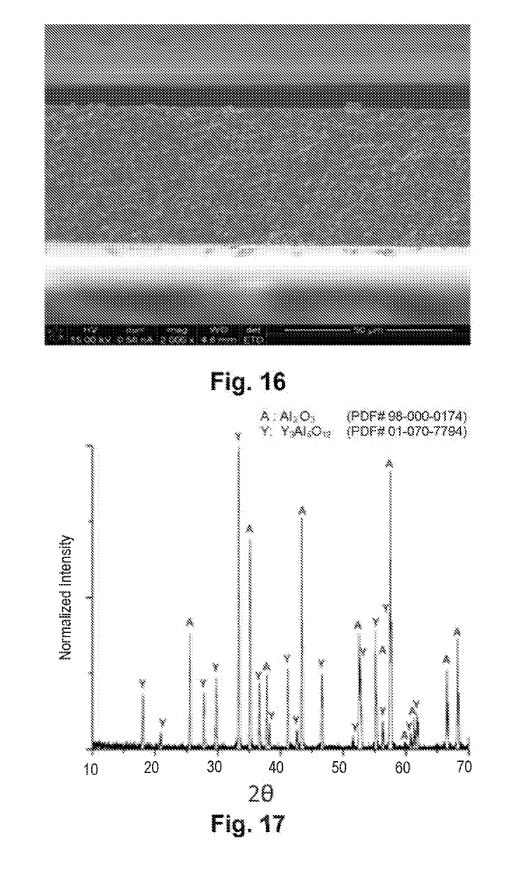

The synthesized nanopowders were dispersed in ethanol without any dispersant using an ultrasonic horn or ball-milling. After 4 to 10 h of settling, supernatant with dispersed powder was decanted, solvent removed and the recovered powders dried at 50° to 70° C. until all solvent was removed. The isolated nanopowders were ball-milled with polymeric additives to form a suspension as described in Example 1. The resulting suspension was cast, cut, and thermo-compressed using methods similar to that detailed in Example 1. Thermo-compressed green films were debindered and then heated to 1400-1600° C. at 5-15° C. min⁻¹ in flowing synthetic air and held for 1 to 20 h. The densities of the resulting 10-100 μm thick films were >90%. FIG. 16 shows a SEM fracture surface image of the resulting sintered Al₂O₃—Y₃Al₅O₁₂ film and FIG. 17 shows an XRD spectrum of the sintered Al₂O₃—Y₃Al₅O₁₂ film.

### Example 7—Sintered Al₂O₃—Y₃Al₅O₁₂—Y:ZrO₂ Oxide Composite Films

Nanopowders in nominal compositions ZrO₂, Al₂O₃ and Y₂O₃ were synthesized by LF-FSP. Zirconium isobutyrate, alumatrane, and yttrium propionate were dissolved in ethanol at 1 to 5 wt. % but preferably at 1 to 3 wt. % and subsequently aerosolized and combusted in an oxidizing atmosphere using LF-FSP as detailed in prior art. Powder were processed, and green films were cast in same methods as described in previous examples.

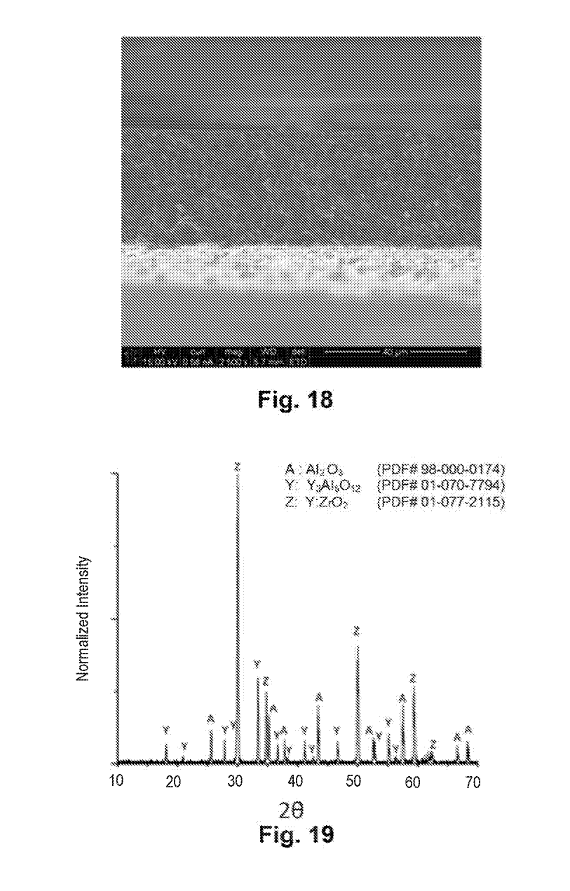

Thermo-compressed green films were debindered and then heated to 1400-1600° C. at 5-15° C. min⁻¹ in flowing synthetic air and held for 1 to 20 h. The densities of the resulting 10-100 μm thick films were >90%. FIG. 18 shows a SEM fracture surface image of the resulting sintered Al₂O₃—Y₃Al₅O₁₂—Y:ZrO₂ composite film and FIG. 19 shows an XRD spectrum of the sintered Al₂O₃—Y₃Al₅O₁₂—Y:ZrO₂ composite film.

### Example 8—Sintered Ni—Y₃Al₅O₁₂ Intermixed Composite Films

Nanopowders in nominal compositions of NiAl₂O₄ and Y₂O₃ were synthesized by LF-FSP process. Yttrium propionate, alumatrane, nickel acetate tetrahydrate at selected molar ratio were dissolved in ethanol at 1 to 5 wt. % but preferably at 1 to 3 wt. % and subsequently aerosolized and combusted in an oxidizing atmosphere using LF-FSP as detailed in prior art.

The synthesized NiAl₂O₄ and Y₂O₃ nanopowders were dispersed in ethanol without any dispersant using an ultrasonic horn or ball-milling. After 4 to 10 h of settlement, supernatant was decanted and dried at 50 to 70° C. until all solvent was removed. The cleaned nanopowders were ball-milled with polymeric additives to form a suspension as described in Example 1.

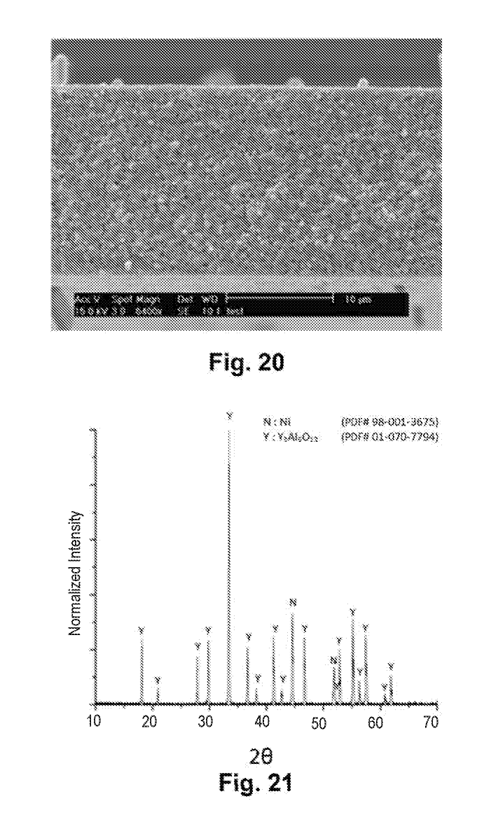

Green films of NiAl₂O₄:Y₂O₃ at 5:3 molar ratio mixture was cast. Green films were cast, cut, and thermo-compressed at 5,000-10,000 psi for 5-10 min. The resulting green films were debindered at 700° C./2 h/air (60 ml min⁻¹), and subsequently sintered to 1500° C./0 h followed by 1300° C./10 h in H₂/N₂ (100 ml min⁻¹). FIG. 20 shows a SEM fracture surface image of the resulting sintered Ni—Y₃Al₅O₁₂ intermixed composite and FIG. 21 shows an XRD spectrum of the sintered Ni—Y₃Al₅O₁₂ intermixed composite.

### Example 9—Sintered Ni—Y₃Al₅O₁₂ Lamellar Composites

Nanopowders in nominal compositions of Y₂O₃, Al₂O₃ and NiO were synthesized by LF-FSP process. Yttrium propionate, alumatrane, nickel acetate tetrahydrate at selected molar ratio were dissolved in ethanol at 1 to 5 wt. % but preferably at 1 to 3 wt. % and subsequently aerosolized and combusted in an oxidizing atmosphere using LF-FSP as detailed in prior art.

The synthesized Y₂O₃, Al₂O₃ and NiO nanopowders were dispersed in ethanol without any dispersant using an ultrasonic horn or ball-milling. After 4 to 10 h of settlement, supernatant was decanted and dried at 50 to 70° C. until all solvent was removed. The cleaned nanopowders were ball-milled with polymeric additives to form a suspension as described in Example 4.

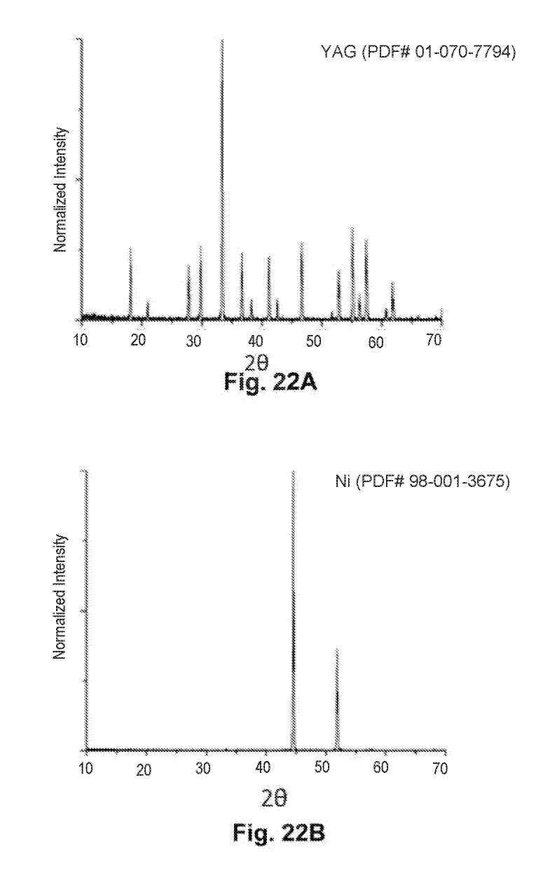

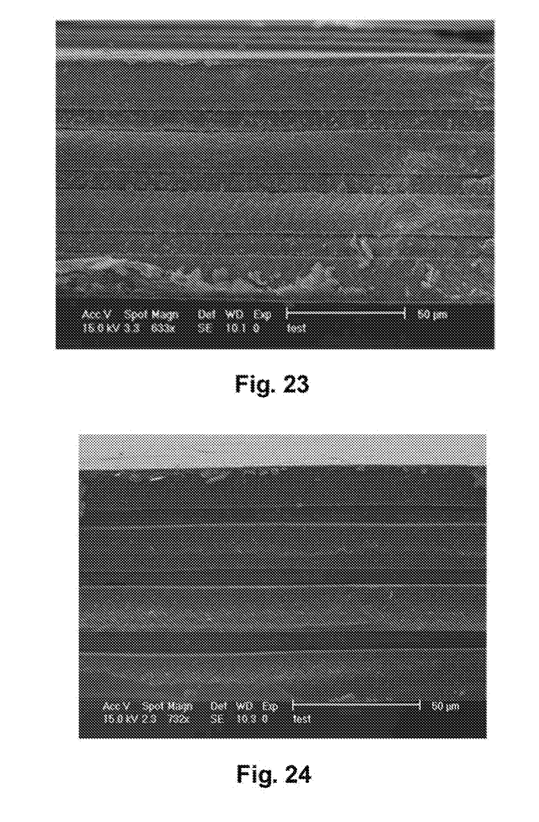

Green films of Y₂O₃:Al₂O₃ at 3:5 molar ratio mixture was cast for YAG (Y₃Al₅O₁₂) layer. Green films of NiO were cast targeting production of a metallic layer. Both green films were cast, cut, stacked in an alternating fashion of Y/N/Y/N/Y/N/Y (Y=YAG, N═NiO), and thermo-compressed at 5,000-10,000 psi for 5-10 min. The resulting stacked green films were debindered at 700° C./2 h/air (60 ml min⁻¹), and subsequently sintered to 1300-1500° C. for 10-30 h in H₂/N₂ (100 ml min⁻¹) to generate a lamellar YAG/Ni film. FIGS. 22A and 22B show XRD of YAG and Ni films, wherein FIG. 22A shows single phase YAG and FIG. 22B shows single phase Ni. FIG. 23 shows a SEM image of the lamellar YAG/Ni film, wherein the outermost layers are YAG.

### Example 10—Sintered Ni—ZrO₂/Al₂O₃ Lamellar Composites

Composite nanopowders of ZrO₂/Al₂O₃ were produced by LF-FSP process as detailed in prior art. Green films were formulated as detailed in aforementioned examples. The resulting ZrO₂/Al₂O₃ composite nanopowder green films were laminated in an alternating fashion with NiO green film as detailed in example 9. The resulting stacked green films were debindered at 700° C./2 h/air (60 ml min⁻¹), and subsequently sintered to 1100-1500° C. for 10-30 h in H₂/N₂ (100 ml min⁻¹). FIG. 24 shows a SEM image of a resulting sintered Ni—ZrO₂/Al₂O₃ lamellar composite.

### Example 11—Sintered ZrO₂—Al₂O₃ Composites with Sharp Edges

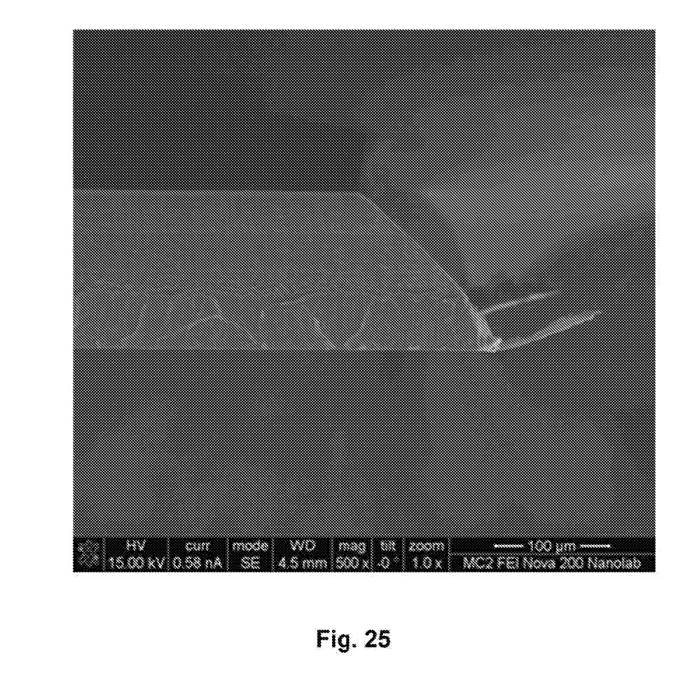

Green films of composite nanopowders of ZrO₂—Al₂O₃ as detailed in prior art were stacked to form thick films (50-200 μm). The stacked film was cut with a razor blade at an angle to generate a sharp edge. Resulting green film was sintered to 1100-1500° C. for 10-30 h in air (100 ml min⁻¹). FIG. 25 shows a SEM image of a resulting sintered ZrO₂—Al₂O₃ composite with a sharp edge.

### Example 12—Sintered Films Coated with a Second Layer

Any of the films used as examples above may be coated with a preceramic polymer precursor that is spray, dip or roller coated or is coated with a polymer film produced as described in background and then heated to the point where this coated film is transformed into a thin, dense or porous ceramic coating to provide an interfacial layer that can be further processed for generating multilayer composites. The above precursors to LiPON represent one example of a polymeric precursor that can be used in this example.

### Example 13—Pressure-Less Sintered Dense Cubic-Li₇La₃Zr₂O₁₂ Ceramic Thin Films for Next Generation Lithium Batteries

Ceramic electrolytes are described as key components in resolving challenges extant in developing next generation, high energy density Li batteries by partially or fully replacing liquid electrolytes to improve overall safety and performance. Among numerous candidates, cubic-Li₇La₃Zr₂O₁₂ (c-LLZO) offers multiple desirable properties, i.e., high ionic conductivities, excellent Li stability, a wide electrochemical operating window and pH stability. However, its incorporation into prototype cells has yet to be demonstrated as c-LLZO membranes (<100 μm) are not available. The possibility of producing thin films matching bulk counterpart properties remains a very difficult processing target arising from energy and/or equipment intensive sintering, Li volatilization, and contamination from ceramic crucibles. Here, first examples of dense (94±1%) c-LLZO thin (<30 μm), flexible films with high ionic conductivities (0.2±0.03 mS cm-1) prepared by conventional casting-sintering of flame made nanoparticles, overcoming the aforementioned challenges are presented. The availability of c-LLZO membranes greatly improves the selection of complementary cell components and simplifies battery configurations broadening opportunities for cell designs.

Lithium ion batteries (LIBs) continue to power modern society. However, newly emerging applications that require bulk battery systems or low temperature operation mandate new battery designs, electrochemistries, and materials to meet target performance specifications. Multiple next generation LIBs designs have been proposed that offer 2-10× higher energy storage per mass/volume compared to current LIBs. However all use Li anodes due to their high theoretical capacity (3860 mAh g⁻¹).

In terms of electrolytes, all commercial LIBs use lithium salts dissolved organic carbonate liquid electrolytes. However, such electrolytes suffer from multiple drawbacks including narrow operating windows based on thermal and electrochemical stability. They also suffer from poor conductivities below ambient. Typical degradation temperatures ≥60° C. mandate the use of thermal management peripherals to avoid catastrophic failure. Similarly, electrochemical operating windows of 3 to 5 V also limit charge discharge rates and likewise mandate external peripherals. Also, the use of different anode and cathode materials in prototypical next generation LIBs have given rise to compatibility issues in selected cell chemistries resulting in decomposition or reaction.

Oxide electrolytes with ionic conductivities similar to liquid/separator couples (0.1-1 mS cm⁻¹) are now proposed to replace liquid electrolytes to further improve and/or stabilize cell chemistries. To this end, c-LLZO has received immense attention as it exhibits a combination of desirable characteristics: high ionic conductivities (0.1-1.4 mS cm⁻¹), mechanical strength (50-60 GPa, shear modulus), a wide electrochemical stability window (0-6 V), and most importantly Li stability. Despite the interest, most prototype cells use relatively thick Li phosphate membranes (50-200 μm). Such membranes offer limited protection from reduction by Li during cycling and at these thicknesses ionic conductivities are far from optimal and their potential to be used in multi-cell LIBs for bulk storage applications. Indeed, first examples of such membranes at 20 μm thicknesses have recently been reported and reducing the thicknesses to 10 μm is possible, but still with the Li reduction problem extant.

Multiple articles have been devoted to assessing the material challenges in developing next generation LIBs in terms of stability and compatibility, and one very important aspect is overlooked, i.e., material processing challenges. Unlike liquids or polymers, oxides require high temperature powder sintering to achieve the high densities needed for optimal performance. Thus, the selection of starting powder(s), processing steps, and sintering conditions are all crucial to obtaining highest possible densities at the lowest possible energy input (cost). Furthermore, processing becomes even more difficult in producing thin films.

In order for c-LLZO to be used in actual cells, it must be incorporated in thin film forms, preferably <50 μm. However, no dense, thin c-LLZO films with ionic conductivities equivalent to those found in high density, bulk counterparts (>10⁻⁴ S cm⁻¹) have been reported to date likely due to the energy intensive and rather problematic sintering processes involved. Normal sintering conditions are 1100-1250° C. for 10-40 h. However, Li (as Li₂O) volatilizes rapidly at these temperatures presenting exceptional challenges in producing thin films given their much higher surface/volume ratios leading to faster Li loss.

Multiple attempts to reduce processing conditions by introducing sintering aids or using submicron- to nano-particles have met with little success. In contrast, hot-pressing, provides access to ≈fully dense pellets with superior bulk ionic conductivities. However, such an approach may be problematic from a commercialization standpoint. Hence, there is considerable need to develop an economical route to c-LLZO thin films. A solution to low cost, mass production of ceramic electrolyte thin films by adopting two proven methods of mass production; flame spray pyrolysis and conventional casting-sintering is now provided. On another note, deposition or sputter derived c-LLZO films are not considered here as they may find use in 2-D thin film batteries but are unlikely to be useful for bulk battery systems.

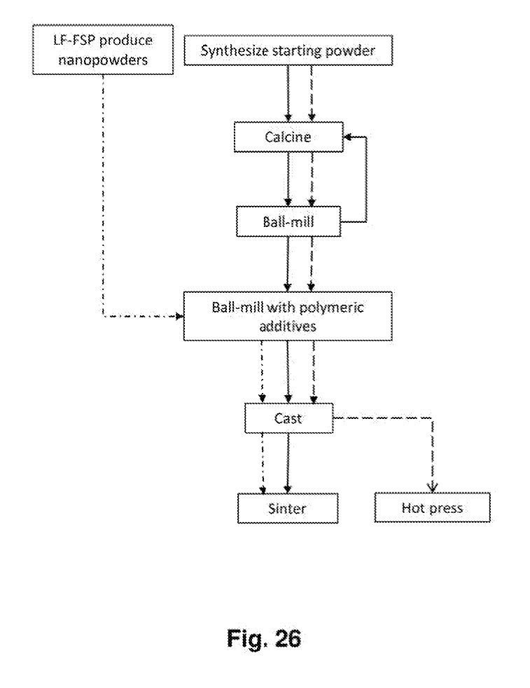

Conventional sintering of c-LLZO requires 10-40 h of dwell at temperatures above 1100° C. where Li easily volatilizes. Furthermore, repeated calcination and ball-milling to obtain powders for pellet compaction are also time and energy intensive. Pellets are covered in mother powder during sintering to reduce Li loss. In contrast, hot-pressing shortens the sintering time to 1 h at lower temperatures of 1000-1050° C. to result in near full densities with the aid of pressure. Note the powders used for hot-pressing are also ball-milled and calcined. FIG. 26 is a flow chart showing a comparison of potential processing routes.

New constraints surface on transferring known approaches to forming thin films. First, mother powders cannot be used, since they will sinter to the films which will be difficult to remove without fracturing a resulting film. For hot-pressing, the film may crack during sintering due to uneven pressure. Also, even if it is possible to sinter thin films under certain conditions there are other limits; scalability, utility in shaping, cost. Hence, an alternate route of processing flame made nanoparticles to drive densification to reduce external energy required to reach high final densities is desired.

The characterization of liquid-feed flame spray pyrolysis (LF-FSP) produced LLZO powders and efforts to transform the powders into dense c-LLZO films are discussed.

Precursor synthesis. Four types of precursors were synthesized in this study to serve as a source of Li, Al, La, and, Zr, respectively. Lithium propionate [LiO₂CCH₂CH₃] and alumatrane [Al(OCH₂CH₂)₃N] were synthesized as described elsewhere. Lanthanum isobutyrate [La{O₂CCH(CH₃)₂}₃] was synthesized by reacting lanthanum oxide (130 g, 0.4 mole) with isobutyric acid (530 g, 6 mole) in a 1 L round bottom flask equipped with a still head at 140° C. in N₂ atmosphere. Once transparent liquid was obtained, heat was removed and lanthanum isobutyrate crystallized on cooling which was filtered out. Zirconium isobutyrate [Zr{O₂CCH(CH₃)₂}₂(OH)₂] was synthesized by reacting zirconium basic carbonate (86 g, 0.28 mole) with isobutyric acid (390 g, 4.4 mole) and isobutyric anhydride (350 g, 2.2 mole) in the same manner with lanthanum isobutyrate synthesis.

Powder synthesis. Nanopowders of Li_{6.25}Al_{0.25}La₃Zr₂O₁₂ composition with 50 wt. % excess lithium were synthesized by liquid-feed flame spray pyrolysis (LF-FSP) method. Extra lithium is intended to compensate its loss during sintering. Lithium propionate, alumatrane, lanthanum isobutyrate, and zirconium isobutyrate, were dissolved in ethanol at selected molar ratios to give a 3 wt. % ceramic yield solution. The precursor solution was aerosolized with oxygen into a quartz chamber where it was combusted with methane/oxygen pilot torches in an oxygen rich environment. Resulting nanopowders were collected downstream in rod-in-tube electrostatic precipitators (ESP) operated at 10 kV. LF-FSP process is described in detail in our previous work.

Powder and film processing. As-produced powders were first dispersed in EtOH (200 proof, Decon Labs) with 2 wt. % polyacrylic acid (Mₙ=2000, Sigma-Aldrich) dispersant, using an ultrasonic horn (Vibra cell VC-505, Sonics and Materials, Inc.) at 100 W for 15 min. The suspension was let settle for 4 h to allow larger particles to settle. Supernatant was decanted and dried. Collected powder, polyvinylbutyral, benzyl butyl phthalate, acetone, and ethanol at selected wt. ratio (Table 1) were added to a 20 ml vial and ball-milled with 3.0 mm diameter spherical ZrO₂ beads for 12-24 h to homogenize the suspension. Suspensions were cast using a wire wound rod coater (Automatic Film Applicator-1137, Sheen Instrument, Ltd). Film thicknesses were controlled by adjusting the gap between the rod and the substrate. Dried green films were manually peeled off the MYLAR® substrate, and cut to selected sizes. Green films were uniaxially pressed in between stainless steel dies at 80-100° C. with a pressure of 50-70 MPa for 5-10 minutes using a bench top press equipped with a heater (Carver, Inc.) to improve packing density.

Film sintering. Green films were placed in between graphite foils and heated to selected temperatures and dwell times in N₂ (100 ml min″¹). Graphite foils were used to avoid any possible contamination or reaction with common ceramic crucibles. The resulting films had carbon deposits which were removed by reheating to 750-850° C. for 1-4 h in air. Films were placed on MgO plates during carbon removal.

X-ray diffraction. Measurements were carried out using a Rigaku Rotating Anode Goniometer (Rigaku Denki., LTD., Tokyo, Japan). Scans were made from 10 to 70° 28, using a scan rate of 5° min⁻¹ in 0.01° increments and Cu Kα radiation (1.541 Å) operating at 40 kV and 100 mA. Scan rate of 1° min⁻¹ in 0.01° increments was used for as-produced powder mixed with α-Al₂O₃ internal standard. The Jade program 2010 (Version 1.1.5 from Materials Data, Inc.) was used to determine the presence of crystallographic phases, wt. fraction, and to refine lattice constants. Following reference files were used; c-LLZO (PDF#04-018-3158) t-LLZO (PDF#01-080-6140), La₂Zr₂O₇ (PDF#01-070-5602), La₂O₃ (PDF#04-008-8233), Li₂CO₃ (PDF#98-000-0473), a-Al₂O₃ (PDF#98-000-0174).

N₂ adsorption. Specific surface areas (SSA) were obtained using a Micromeritics ASAP 2020 sorption analyzer. Samples (400 mg) were degassed at 300° C./5 h. Each analysis was run at −196° C. (77 K) with N₂. The SSAs were determined by the BET multipoint method using ten data points at relative pressures of 0.05-0.30. SSA was converted to average particle sizes (APS) using the equation APS=6/(SSA×ρ). The net density (p) of the as-produced powder was approximated by rule of mixture. Density of stoichiometric La₂Zr₂O₇ was used as an estimate.

Scanning electron Microscopy. Micrographs were taken using a FEI NOVA Nanolab system (FEI company). Powder samples were used as is, sintered films were fractured for imaging. All samples were sputter coated with gold using a SPI sputter coater (SPI Supplies, Inc.).

Thermogravimetric analysis. Q600 simultaneous TGA/DSC (TA Instruments, Inc.) was used to observe thermal decomposition of as-produced powders and green films. Samples (15-25 mg) were loaded in alumina pans and ramped to 1000° C. at 10° C. min⁻¹ under constant air flow at 60 ml⁻¹.

Electrochemical impedance spectroscopy. AC impedance data were collected with broadband spectrometer (Novocontrol technologies, Hungdsangen, Germany) in a frequency range of 10 MHz to 1 Hz at −35 to 85° C. in increments of 20° C. Gold electrodes, 1 mm in diameter, were deposited using a SPI sputter coater on one side of the surface using a deposition mask whereas the other side was coated in full.

Density measurements. Final sintered film densities were determined by Archimedes method using ethanol as media.

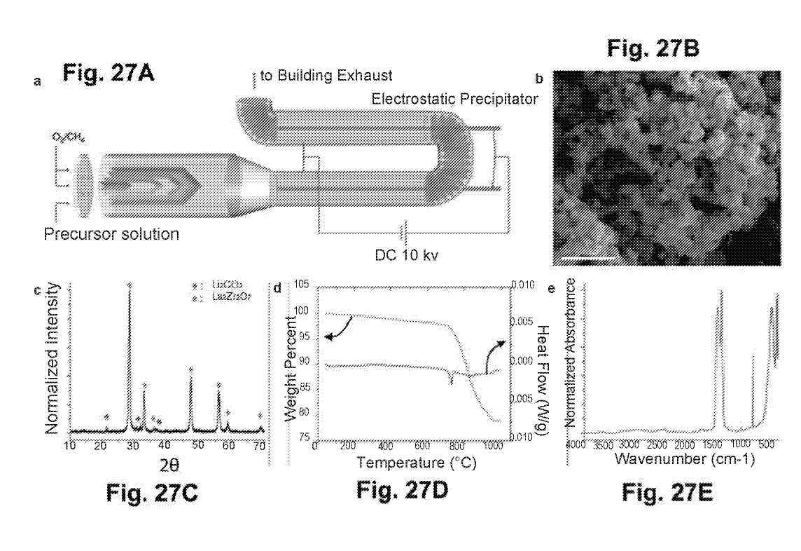

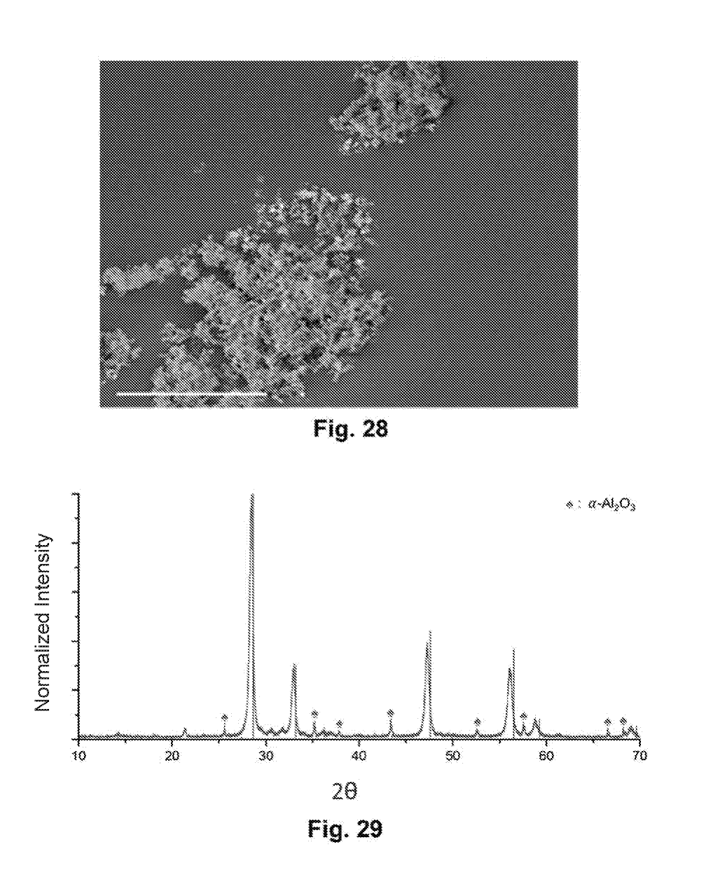

Nanopowders of Li_{6.25}Al_{0.25}La₃Zr₂O₁₂ with 50 wt. % excess lithium were produced using LF-FSP (FIG. 27A). Al³⁺ doping stabilizes the high ionic conductivity cubic phase, and excess Li is used to balance losses incurred during sintering. Ga³⁺ doping can be used in place of Al³⁺ to achieve similar results. It is suggested that sintering 1-2 mm thick pellets requires 10-15 wt. % excess Li, 50 wt. % was chosen here. The resulting spherical nanoparticles offer a narrow size distribution (FIGS. 26B and 27). The BET N₂ adsorption derived specific surface area was 16 m² g⁻¹ with corresponding average particle sizes of ≈90 nm, assuming spherical morphology. While LF-FSP normally generates pure oxides, a mixture of Li₂CO₃ and off-stoichiometric La₂Zr₂O₇ was detected by XRD (FIG. 27C). The combustion byproducts H₂O and CO₂ and high flame temperatures (>1500° C.), either accelerate decomposition or prevent LLZO from forming. For off-stoichiometric La₂Zr₂O₇, LF-FSP provides access to phases or compositions stable at high temperatures due to rapid quenching. XRD peak shifts were confirmed and new lattice constants were refined using α-Al₂O₃ as an internal standard corroborating off-stoichiometry as detailed in FIG. 29. More particularly, an internal standard, α-Al₂O₃, was mixed with as-produced LLZO using a mortar and pestle. Commonly used internal standard Si metal could not be used as it overlaps with La₂Zr₂O₇ peaks. Peak shifts are noted in FIG. 29. Observed off-stoichiometric La₂Zr₂O₇ peaks are shifted left with respect to stoichiometric La₂Zr₂O₇ (red drop lines), indicating larger lattice constants. A new lattice constant of 10.8788 Å was determined by refining using whole pattern fitting of Jade software. This is greater than the stoichiometric lattice constant, 10.7997 Å. Hence, the off-stoichiometric composition is 0.43La₂O₃-0.57ZrO₂ (La₃Zr₂O_{8.5}) which is stable at temperatures of >1550° C. based on the ZrO₂—La₂O₃ binary phase diagram. Rapid quenching of LF-FSP gives access to high temperature phases. TGA shows an endothermic mass loss starting at −700° C., ascribed to Li₂CO₃ melting (FIG. 27D) with a loss of CO₂ ending at −950° C. FTIR (FIG. 27E) shows vC=O for carbonates (750, 1400-1600 cm⁻¹) as well as vM-O (<500 cm⁻¹).

Green films were produced by conventional ball-milling and casting. LLZO nanopowders were ball milled with dispersant, binder, plasticizer, and solvents per Table 2. This method provides an efficient route to c-LLZO, and form thin films by carefully controlling processing variables, such as starting powder, wet processing, and sintering conditions. After 12-24 h of ball-milling, the homogenized suspension was bar cast on MYLAR® sheets. Compared to common pellet compaction studies wherein nanoparticle agglomerates result in pores after sintering, wet processing of powders breaks down agglomerates during ball-milling and gives uniform particle packing within the polymeric matrix, beneficial to sintering. It is important to formulate a stable system such that particles do not flocculate during the drying process. Table 2 shows starting materials and compositions for a suspension formulation. Polymeric additives are selected as commonly used binder and plasticizer. Solvent system was selected empirically. All starting materials were added into a 20 ml vial and ball-milled for 12-24 h. ZrO₂ milling media was used to avoid contamination. Sum of wt. % is not 100 due to rounding off.

TABLE 1
Reported sintering conditions and properties of c-LLZO {(Li_{7-2x-y}AₓLa₃Zr_{2-y}ByO₁₂, (A³⁺, B⁵⁺)}

| | | | | RT Ionic | | |
|---|---|---|---|---|---|---|
| | | | % | conductivity | | |
| | Dopant(s) | Sintering condition | density | (mS cm⁻¹) | Remark | Ref. |
| Solid state | n/a | 1230° C./36 h/air | 92 | 0.24 | Likely Al³⁺ contamination from | 1 |
| reaction | | | | | crucible. Covered in mother powder. | |
| | Al³⁺ | 1230° C./36 h/air | n/a | 0.18 | Covered in mother powder. | 2 |
| | Nb⁵⁺ | 1200° C./36 h/air | 92 | 0.8 | n/a | 3 |
| | Ta⁵⁺ | 1140° C./16 h/air | 94 | 1.02 | Covered in mother powder. | 4 |
| | Al³⁺/Ta⁵⁺ | 1140° C./9 h/O₂ | 96 | 0.74 | | 5 |
| | Al³⁺ | 1100° C./12 h/air | 92 | 0.25 | Attrition milled (~1 μm powder). | 6 |
| | | | | | Covered in mother powder. | |
| Spray pyrolysis | Al³⁺ | 1000° C./1 h/air | 51 | 0.0044 | Fully decomposed starting powder. | 7 |
| | | | | | Covered in mother powder. | |
| Sol-gel | Al³⁺ | 900° C./(n/a)/air | n/a | 0.0024 | Sol-gel dip coating. | 8 |
| | | | | | Li₂CO₃ placed near to retard Li loss. | |
| | Al³⁺ | 1200° C./10 h/air | 96 | 0.61 (33° C.) | Li₄SiO₄ sintering additive. | 9 |
| | | | | | Covered in mother powder. | |
| Co-precipitation | Nb⁵⁺ | 1100° C./36 h/air | 87 | 0.52 | Covered in mother powder. | 10 |
| Pechini method | Al³⁺ | 1200° C./6 h/air | 92 | 0.2 | | 11 |
| Hot press | Ta⁵⁺ | 1050° C./1 h/Ar/62 MPa | 98 | 0.82 | Co-precipitation derived powder. | 12 |
| | | | | | No mother powder. | |
| | Al³⁺ | 1000° C./1 h/Ar/40 MPa | 96 | 0.4 | Sol-gel derived powder. | 13 |
| | | | | | No mother powder. | |
| | Al³⁺ | 1000° C./1 h/Ar/40 MPa | 98 | 0.4 | Solid state reaction derived powder. | 14 |
| | | | | | No mother powder. | |
| Flame Spray | Al³⁺ | 1090° C./1 h/N₂ | 94 | 0.2 | Fully decomposed starting powder. | This |
| Pyrolysis | | | | | No mother powder. | work |

TABLE 2
Starting materials and composition for suspension formulation

| | Role | Wt. % |
|---|---|---|
| LLZO with 2 wt. % polyacrylic | Powder/dispersant | 37 |
| acid | | |
| Benzyl butyl phthalate | Plasticizer | 3 |
| Polyvinyl butyral | Binder | 3 |
| Ethanol | Solvent | 29 |
| Acetone | Solvent | 29 |

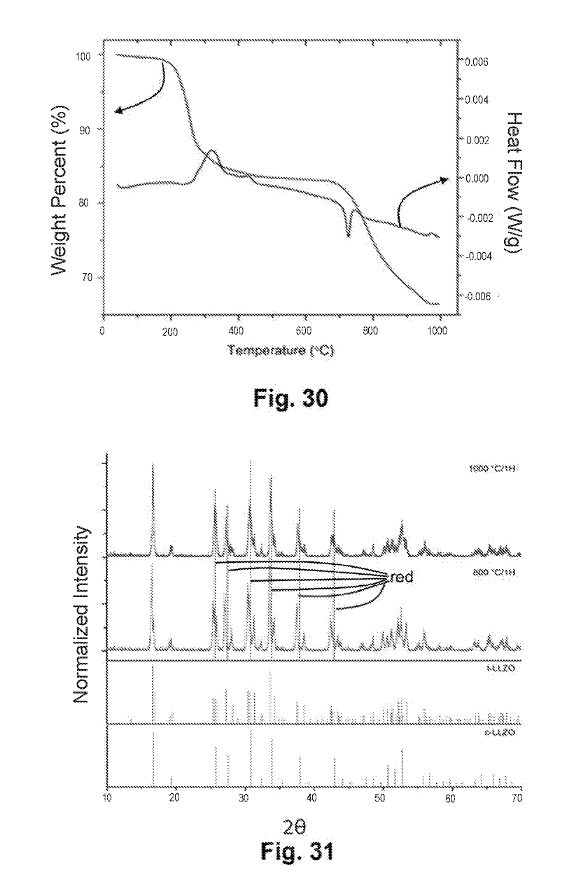

Dried green films were removed from the substrate and thermo-compressed between stainless steel plates for 5-10 min at 80-100° C. and 50-70 MPa. Thermo-compression is an effective method of improving green densities thereby reducing sintering temperatures, times and providing sintered bodies with higher relative densities. One can envision continuous processing using this approach which is similar to tape casting followed by calendering. Added benefits to this approach include utility in forming shapes since the green tape is easily cut to desired shapes and sizes. TGAs of green films were run to confirm the solids loading prior to sintering (FIG. 30). Initial 2 wt. % mass loss at <200° C. is ascribed to removal of residual solvent and/or physi-/chemi-sorbed water. The following mass losses with exotherms are due to oxidative decomposition of polymeric additives; dispersant, binder, and plasticizer. Most polymeric additives are oxidatively removed at ˜450° C. and the mass remains stable to ˜680° C. An endotherm attributed to melting of Li₂CO₃ is observed near 720° C. accompanied by mass loss as CO₂ evolves, in accordance with the TGA-DSC of the as-produced powder (FIG. 27D). Final ceramic yield is ˜66 wt. %, in good agreement with theoretically expected based on Table 2. Note the ceramic yield of LLZO with 2 wt. % PAA dispersant itself is ˜77 wt. %.

Given there is a limited reservoir of Li in the starting LLZO nanopowder (50 wt. % excess), densification must be complete before it volatilizes completely, preferably resulting in single-phase c-LLZO. Hence, a short dwell time of 1 h was selected in targeting optimal densification. Indeed, extended dwell below the sintering temperature generated c-LLZO but with low relative densities. Green film thicknesses were fixed at 45±2 μm for this set of experiments since it is also a variable. Tetragonal-LLZO (t-LLZO) was first observed at 800° C. as expected due to excess Li (FIG. 31), known to drive formation of t-LLZO even with Al³⁺ doping. Further increases in temperature drive Li loss and transform t-LLZO to c-LLZO.

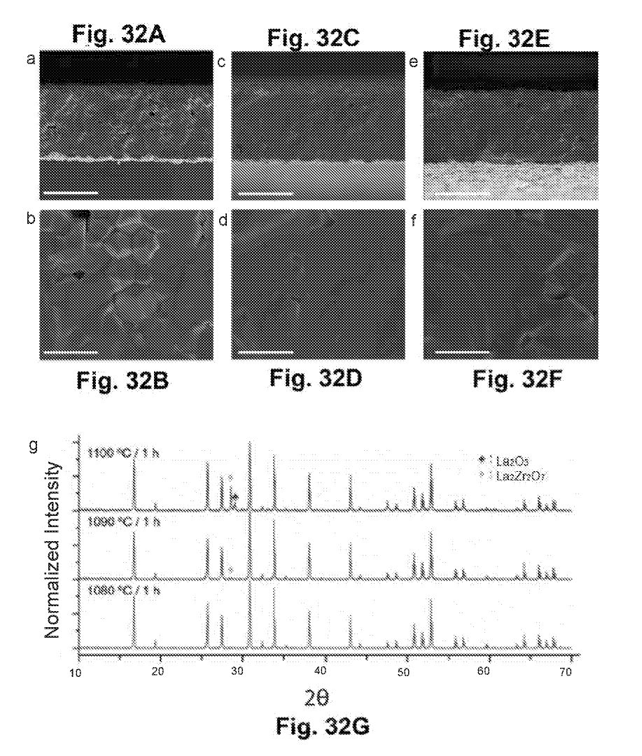

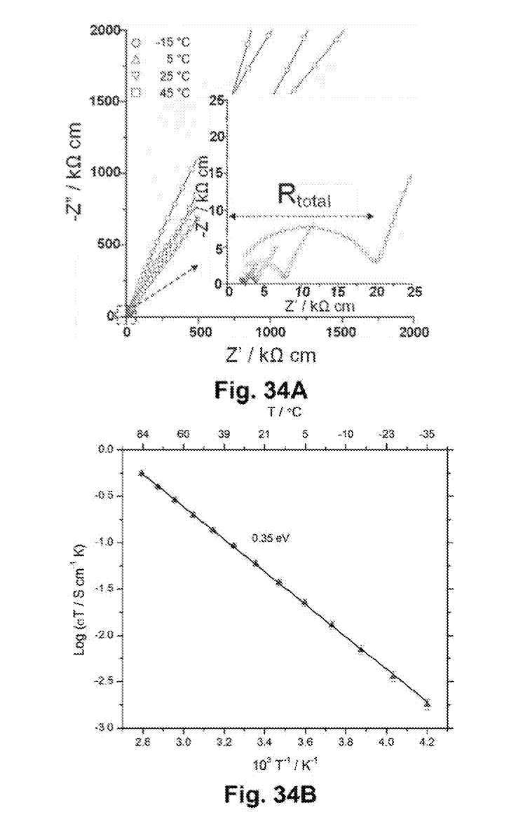

Single-phase c-LLZO was observed at 1080° C./1 h (FIG. 32G) with some closed porosity per the SEM fracture surface image (FIGS. 32A and 32B). On heating to 1090° C./1 h, traces of La₂Zr₂O₇ form (FIG. 32G). Trans-granular fracture surfaces reveal very high relative densities (FIGS. 32C and 32D) and suggest good-to-excellent grain boundary contact. Trans-granular fracture dominates mechanical behavior with increasing relative densities. FIG. 32G shows a 1100° C./1 h sintered sample with secondary phase peaks corresponding to La₂Zr₂O₇ and La₂O₃ with little change in microstructure (FIGS. 32E and 32F). Single phase c-LLZO˜30 μm thick films with high relative densities (94±1%) form on sintering at 1090° C./1 h with ionic conductivities of 0.2±0.03 mS cm⁻¹ (FIG. 34A). These films are the very first examples that meet the above cited challenges.

Sintering times are greatly reduced from 10-40 h to 1 h, and at lower temperatures compared to common solid state reactions methods. This surprising result likely arises from combined effects of uniform particle packing, nanoparticle high surface energies, and chemical reactions of constituent materials including liquid phase sintering promoted by Li₂CO₃. Off-stoichiometric La₂Zr₂O₇ does not seem to be a determining factor since similar starting powders form in sol-gel syntheses that do not dramatically enhance sintering behavior.

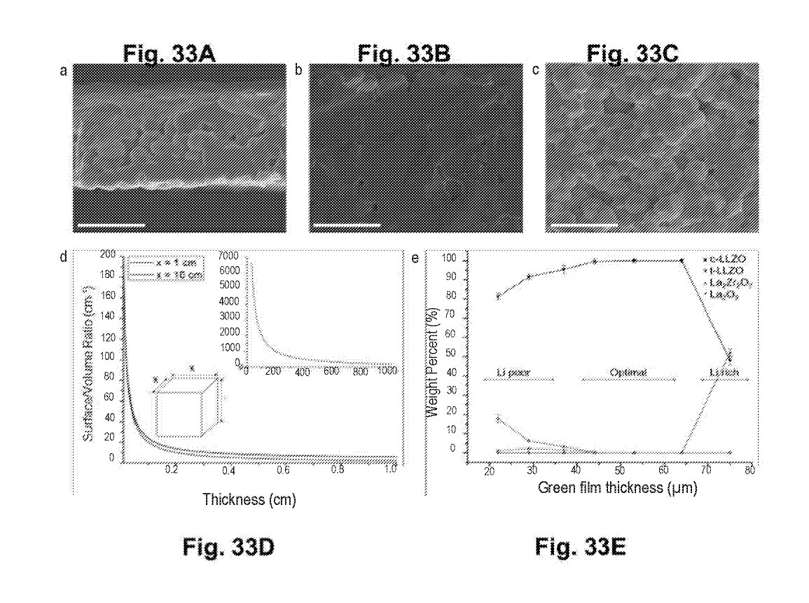

Based on FIGS. 32A-32G it is concluded that c-LLZO thin films' microstructures and phase compositions are very sensitive to sintering temperature; correlated to Li loss rates. Hence another set of experiments was run with the sintering temperature fixed at 1090° C./1 h but with different green film thicknesses. Given Li is lost at the surface, surface/volume ratios become a variable (FIG. 33D). Note that the ratio varies rapidly below 100 μm, indicating final sintered product properties are sensitive to green film thicknesses. Note that 50 μm film surface/volume ratios are ˜100× greater than for 1 mm thick pellets. As such, different sintering conditions are required for samples with different thicknesses. Changes in surface/volume ratio exist with varying lateral dimensions for thick samples but converge to same value as thickness is reduced (FIG. 33D).

As hypothesized, thicker green films showed t-LLZO and thinner green films La₂Zr₂O₇ and La₂O₃ secondary phases when sintered (FIG. 33E) using the same schedule. Li poor, optimal, and Li rich ranges in terms of green film thicknesses were determined based on the phase composition and microstructure (FIGS. 33A, 33B, 33C, and 33E). Li poor films show low relative densities as secondary phases La₂Zr₂O7 (6.04 g cm⁻³) and La₂O₃ (5.98 g cm⁻³) have higher densities compared to c-LLZO (5.10 g cm⁻³). Thicker films also gave low relative densities suggesting that t-LLZO does not sinter at this temperature whereas c-LLZO does.

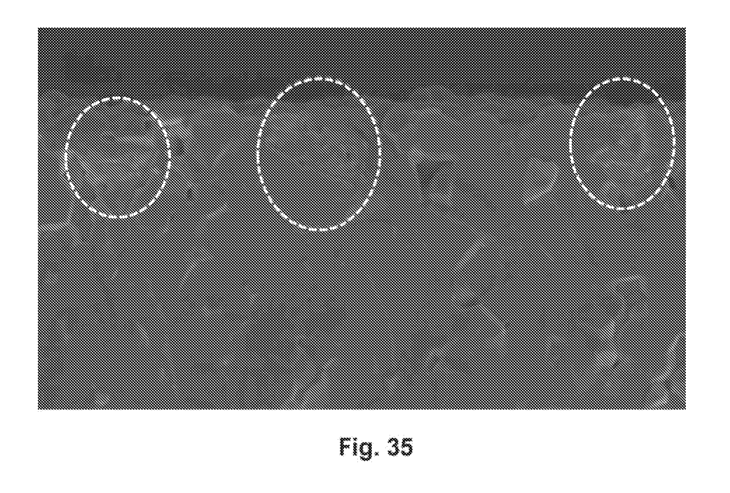

Sintered films' electrochemical properties were measured. Nyquist plots show semi-circles at high frequencies followed by a spike at low frequencies, typical of ion conductors with blocking electrodes (FIG. 34A). Conductivities were calculated approximating the lowest point of the spike as the total resistance and considering dimensional factors. Typical room temperature conductivities of 0.2±0.03 mS cm⁻¹ and activation energies of 0.35±0.01 eV were obtained (FIGS. 34A and 34B), in good agreement with high density pellets counterparts. No noticeable grain boundary resistance was observed due to superior grain boundary contact. In comparison, c-LLZO films with low relative densities showed grain boundary resistance and lower ionic conductivities (FIG. 35). The circled areas in FIG. 35 show distinctly different microstructural features. It is likely these are the initiation points for formation of the secondary phases La₂Zr₂O₇ and La₂O₃ as Li₂O is lost at the surface with excessive heating. Ionic conductivities of 0.008 to 1.5 mS cm⁻¹ were measured at −35 to 85° C. (FIG. 34B) demonstrating a wide operational temperature window, including temperatures inaccessible using common liquid electrolytes due to decomposition, flammability, or freezing. It is anticipates that still higher operating temperatures leading to faster charge discharge rates are accessible in LIBs.

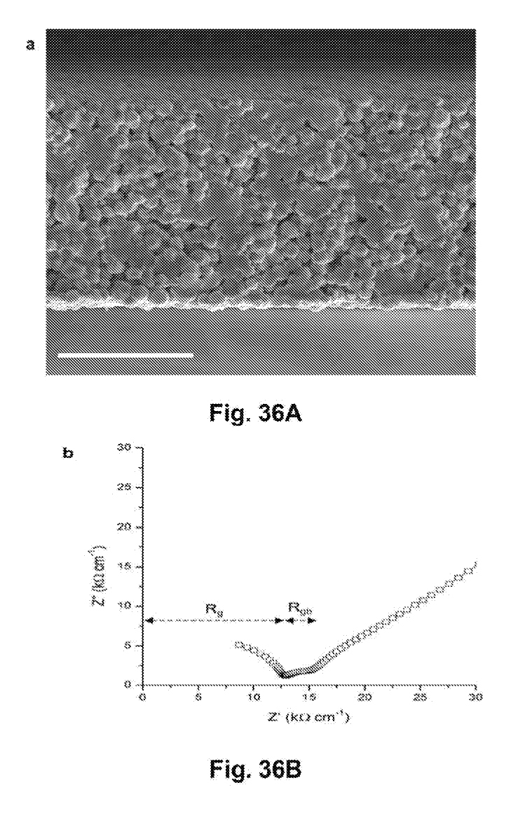

FIGS. 36A and 36B demonstrate ionic conductivities of low relative density c-LLZO thin films. Films sintered at 1070° C. for 2 h did not fully densify, showing porosity. Mixed inter- and trans-granular fracture modes are observed (FIG. 36A). XRD confirmed single phase c-LLZO (FIG. 36B). Nyquist plot shows both grain and grain boundary resistance component. Total ionic conductivity is calculated as 0.07±0.01 mS cm⁻¹.

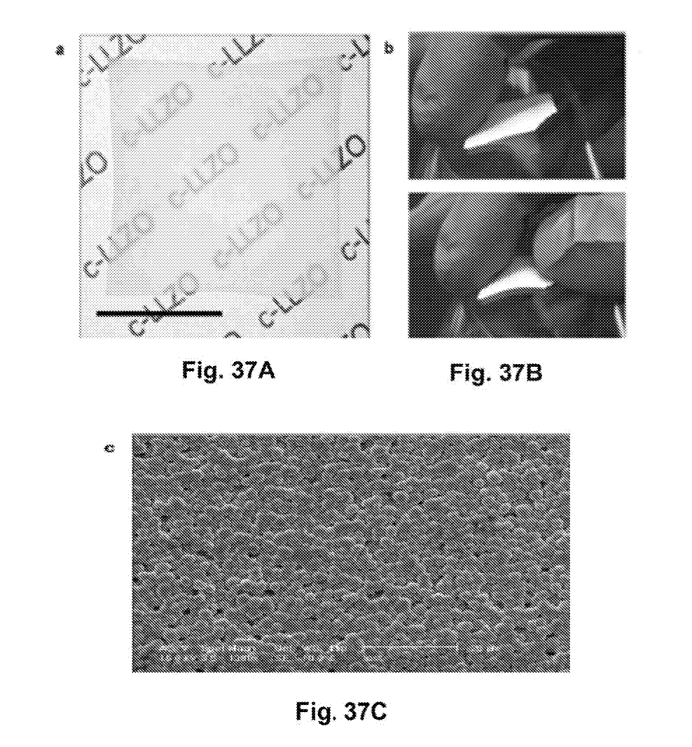

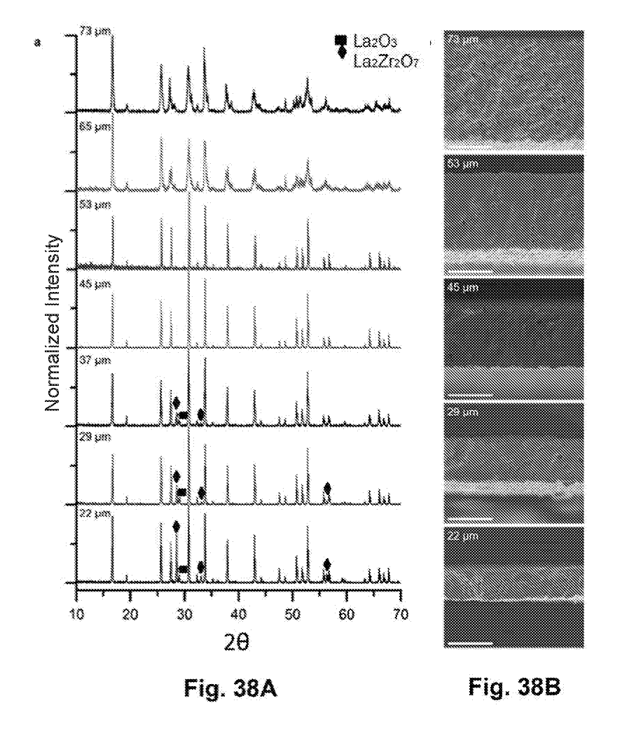

Sintered 30 μm thick films with 2×2 cm² lateral dimensions were produced that are translucent at high relative densities (FIG. 37A), flexible (FIG. 37B). Average grain sizes are 2.4±0.4 μm which translates to 10-15 grains thick film (FIG. 37C). The effect of film thicknesses (Li loss rate) on microstructure and phase composition is shown in FIGS. 38A and 38B.

In conclusion, processing difficulties involved in c-LLZO sintering are overcome by starting with nanoparticles and wet processing to minimize agglomerate formation. The first examples of c-LLZO thin films (20-30 μm thick) with properties similar to its bulk counterpart are demonstrated. Surface/volume ratio is determined as a critical factor in sintering due to Li volatility. Cell assembly and testing can now be done at prototype levels, and the film thicknesses achieved here potentially enable higher energy storage densities in assembled cells. Also, the films produced here can be used in aqueous Li cells or solid state Li-air cells to replace the commonly used thick, commercial LATP membranes (50-150 μm).

### Example 14—Liquid-Feed Flame Spray Derived [NiO]_{0.25}[Al₂O₃]_{0.75} and [NiO]_{0.50}[Al₂O₃]_{0.50} Nanopowders are Easily Processed to Thin, Dense, Flexible NiAl₂O₄—Al₂O₃ and Ni—Al₂O₃ Composite Films

Liquid-feed flame spray pyrolysis (LF-FSP) provides phase-pure [NiO]_{0.25}[Al₂O₃]_{0.75} spinel nanopowders (NPs) with limited aggregation and good stoichiometric control. The processing of [NiO]_{0.25}[Al₂O₃]_{0.75} thin films as a first step in preparing Ni:Al₂O₃ nanocomposite thin films for catalytic applications, especially solid oxide fuel cells (SOFCs), is now provided. NPs were first dispersed in a polymer matrix and cast to give 30±10 μm thin green films. The green films were then debindered at 370° C. and thereafter sintered at 1000-1500° C. in air, then heated at 1000-1100° C. in flowing H₂/N₂ 5:95 targeting reduction to Ni NPs to generate catalyst sites.

Sintering temperatures >1100° C. cause [NiO]_{0.25}[Al₂O₃]_{0.75} to phase segregate to α-Al₂O₃ and [NiO]_{0.5}[Al₂O₃]_{0.5} spinel composites. Increased sintering temperatures leads to increases in α-Al₂O₃ contents with decreases in [NiO]_{0.25}[Al₂O₃]_{0.75} content. Sintering at 1500° C./3 h/air gives dense (95±2% TD), flexible, thin (20±7 μm) films consisting of α-Al₂O₃ and [NiO]_{0.5}[Al₂O₃]_{0.5} spinel with average grain sizes (AGSs) of 1.1±0.3 μm. Further heating at 1100° C./7 h/H₂ forms Ni NPs on film surfaces while retaining flexibility suggesting utility in catalytic applications where mechanical robustness is essential. Increases in NiO:Al₂O₃ ratios from 1:3 to 1:1 results, after reduction in Ni/NiAl₂O₄—Al₂O₃ composite films with higher Ni NP contents targeting materials potentially providing higher catalytic activity.

Spinets are a class of oxides with the general formula AB₂O₄ where oxygen anions are arranged in a cubic close-packed (face-centered) sublattice and cations occupy half the octahedral sites and one-eighth of tetrahedral sites in the lattice. They can be further divided into three types: normal, inverse and intermediate spinels. The distinction between normal and inverse lies in the different cation distributions. In normal spinel structures, A²⁺ and B³⁺ cations occupy tetrahedral and octahedral sites, respectively. However, in inverse spinel structures, all the A²⁺ and half the B³⁺ cations occupy octahedral sites, while the other half, the B³⁺ cations, occupy tetrahedral sites. In addition, there exist some mixed spinels (A₁₋ₓBₓ)[AₓB₂₋ₓO₄] where x represents degree of inversion, (A₁₋ₓBₓ) indicates tetrahedral occupancy, and [AₓB₂₋ₓO₄] indicates octahedral occupancy.

Of the many compounds exhibiting spinel morphologies, nickel aluminates (NiAl₂O₄) are found to be primarily inverse spinels with the nickel ions preferentially occupying the octahedral sites. NiAl₂O₄ spinels have been widely explored due to their multiple potential applications. For example, they can be used as electrode materials in high temperature fuel cells due to their unusual electrical conductivity. Dense ceramics with good mechanical properties (including good flexibility) can also provide excellent thermal stability ensuring safe reliability when used in solid oxide fuel cells (SOFCs). NiAl₂O₄ spinels also have widespread commercial value in catalytic applications including methane- and methanol-steam reforming, hydrocarbon cracking, dehydrogenation, hydrodenitrogenation, etc. Steam reforming catalysts usually consist of fine nickel particles on supported substrates where catalytic activity can be related directly to Ni APSs. Attractively, NiAl₂O₄ as a candidate anode support in SOFC exhibits autogenerated catalysis due to the formation of Ni under reducing conditions. The resulting highly catalytically active Ni NPs can extract H₂ efficiently from fuel at the electrode.

Nickel aluminate spinels are prepared via many methods including solid-state reaction, sol-gel processing, ultrasound irradiation-assisted precursor processing, and ion exchange in zeolites. The most widely used method is solid-state reaction where mixtures of the individual metal oxides are co-sintered. However, phase-pure, high surface area nickel aluminate spinels with controlled stoichiometries are very difficult to obtained especially by solid-state reactions due to high temperatures required for sufficient solid-state diffusion

Fortunately, liquid-feed flame spray pyrolysis (LF-FSP) makes it possible to synthesize a wide variety of mixed-metal oxide nanopowders (NPs) with close to atomic mixing, high purity, limited aggregation, with good control of stoichiometries and phase compositions. LF-FSP generates NPs by combusting oxygen aerosolized alcohol solutions of metalloorganic precursors including metal carboxylates or alkoxides in a 1.5 m long combustion chamber.

Typically, ethanol solutions containing 2-5 wt. % loading of the target ceramic components are aerosolized and ignited using methane/O₂ pilot torches. Initial combustion temperatures run 1000-1500° C. depending on processing conditions such as the methane/O₂ flux, combustion heat of solvents/fuels (alcohol) and precursor solution concentrations. The temperatures at the chamber exit (1.5 m from combustion zone) are 400-500° C. The resulting NP ‘soot’ is quenched rapidly at rates much higher than 1000° C./μs leading to kinetic products, metastable materials, difficult to produce by traditional methods. NPs production rates can be up to 100 g/h, collected 1.5 m downstream in rod-in-tube electrostatic precipitators (ESP) operated at 10 kV.

LF-FSP allows production of NPs with limited aggregation and high special surface areas (SSAs) of 30-100 m²/g and easily manipulated spinel stoichiometries. The above noted utility in various catalyst applications provides motivation to explore its utility in generating NPs along the NiO—Al₂O₃ tie line. LF-FSP generated [NiO]_{0.5}[Al₂O₃]_{0.5} NPs form as inverse spinel, whereas [NiO]_{0.25}[Al₂O₃]_{0.75} NPs consist of a mixed spinel with some Al³⁺ occupying octahedral sites. Both can be used as catalysts.

NiO—Al₂O₃ thin films and their use as catalysts and as electrode materials for fuel cells are now provided. Dense, flexible, thin films with fine grains were processed, then reduced in hydrogen producing fine Ni particles on and in Al₂O₃ thin film matrices targeting novel catalyst systems.

Sample Preparation

Precursor Synthesis—

Alumatrane, Al(OCH₂CH₂)₃N, was synthesized as known in the art. Anhydrous ethanol was purchased from Decon Labs (King of Prussia, Pa.). Nickel acetate, C₄H₆NiO₄, was purchased from Sigma Aldrich (Milwaukee, Wis.) and used as received.

Powder Fabrication—

[NiO]_{0.25}[Al₂O₃]_{0.75} NPs were synthesized by liquid-feed flame spray pyrolysis (LF-FSP). The LF-FSP process is detailed above. Alumatrane and nickel acetate were dissolved in ethanol with a selected molar ratio giving a 3 wt. % ceramic yield. The precursor solution was aerosolized with oxygen and combusted in a chamber with methane/oxygen torches and shield oxygen. NPs were collected mainly in rode-in-tube electrostatic precipitators operated at 10 kV. The as-produced powders were dispersed in EtOH with 2 wt. % bicine as a dispersant via ultrasonication (Vibra-cell VC-505, Sonics & Mater. Inc.). After sedimentation for ca. 1 h, the supernatant suspension was decanted into a container, dried in an oven and collected for use.

Film Processing—

[NiO]_{0.25}[Al₂O₃]_{0.75} NPs were mixed with polyvinylbutyral, benzyl butyl phthalate, acetone, and ethanol in specific ratios (Table 3) were mixed in a 20 mL vial and ball-milled for ca. 24 h with Al₂O₃ beads (ca. 3.0 mm in dia.) obtaining a homogenous suspension. The suspension was cast using a wire-wound rod coater (Automatic Film Applicator-1137, Sheen Instrument, Ltd). The thickness of the as-cast film was controlled by adjusting the gap between the rod and the MYLAR® substrate. Dried green films (30±10 μm in thickness) were manually cut into small pieces, then uniaxially pressed at ca. 50 MPa/140° C./5 min using a heated bench-top press (Carver, Inc.), and then peeled off the substrate. [NiO]_{0.5}[Al₂O₃]_{0.5} NPs and films were processed per the same procedures.

TABLE 3
Starting chemical components for [NiO]_{0.25}[Al₂O₃]_{0.75} film casting

| Components | Roles | Mass (g) | Wt. % | Vol % |
|---|---|---|---|---|
| NiO•3Al₂O₃ | Powder | 1.00 | 33 | 9 |
| Benzyl butyl phthalate | Plasticizer | 0.12 | 4 | 4 |
| Polyvinyl butyral | Binder | 0.12 | 4 | 4 |
| Bicine | Dispersant | 0.02 | 1 | 1 |
| Acetone | Solvent | 0.90 | 29 | 41 |
| Ethanol | Solvent | 0.90 | 29 | 41 |

Film Sintering—

These green films were placed between Al₂O₃ plates and debindered at 370° C. for 1 h in air, then heated to the target temperatures at a ramp rate of 5° C./min. Al₂O₃ plates were used to prevent warping of films throughout the process.

Film Reduction—

Sintered films (1×1 cm×20 μm) were placed on an Al₂O₃ plate and heated to target temperatures at 10° C./min/7 h in 5/95 H₂:N₂ at 100 mL/min.

Thermal Etching—

Sintered films were manually broken to generate fresh fracture surfaces, then heated to designated temperatures for 30 min in air. Thermal etching temperatures were generally 100° C. lower than sintering temperatures.

Sample Characterization

X-Ray Diffraction (XRD)—

Sample phases were identified using a Rigaku Rotating Anode Goniometer (Rigaku Denki., LTD., Tokyo, Japan) operating at 40 kV and 100 mA. Samples were scanned at 2°/min within the range of 10-70° 2θ with 0.02° intervals. As-detected XRD patterns were analyzed using Jade 2010 software (Version 1.1.5 from Mater. Data, Inc.) where JCPDS files were used including Ni (04-001-1136), NiAl₂O₄ (98-000-9338) and α-Al₂O₃ (04-004-2852).

Scanning Electron Microscopy (SEM)—

Sample morphologies were observed by SEM (NOVA Nanolab, FEI Inc.). All the samples were sputter coated with a gold film using a Technics Hummer VI sputtering system (Anatech Ltd., Alexandria, Va.) to improve resolution.

Thermogravimetric/Differential Thermal Analysis (TG/DTA)—

Q600 simultaneous TGA/DTA (TA Instruments, Inc.) was used to analyze thermal decomposition and crystallization of as-cast green films. Ca. 20 mg samples were loaded in an alumina pan and an empty pan was used as a reference. The samples were heated to a target temperature with a ramp rate of 10° C./min in a flowing synthetic air (60 mL/min).

[NiO]_{0.25}[Al₂O₃]_{0.75} Film Processing and Sintering

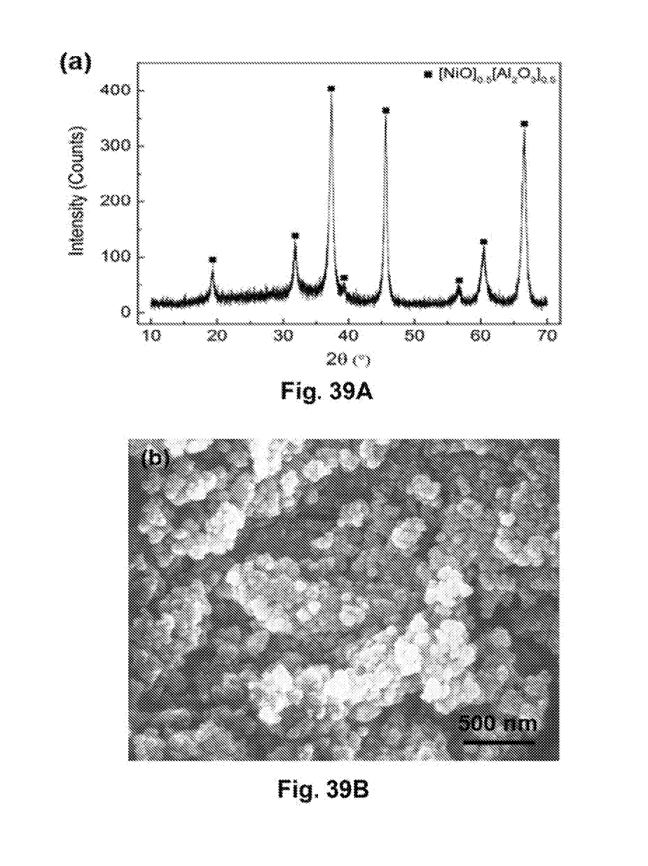

FIG. 39A shows XRD indicating that as-shot [NiO]_{0.25}[Al₂O₃]_{0.75} is single-phase spinel. The broad diffraction peaks are indicative of nanoscale particles. FIG. 39B is a SEM image that shows spherical morphologies for as produced [NiO]_{0.25}[Al₂O₃]_{0.75} NPs, and suggests some agglomeration. Almost all particles appear to be <100 nm causing the broad XRD peaks. The as-produced [NiO]_{0.25}[Al₂O₃]_{0.75} NPs have SSAs up to 60 m²/g offering good sintering behavior.

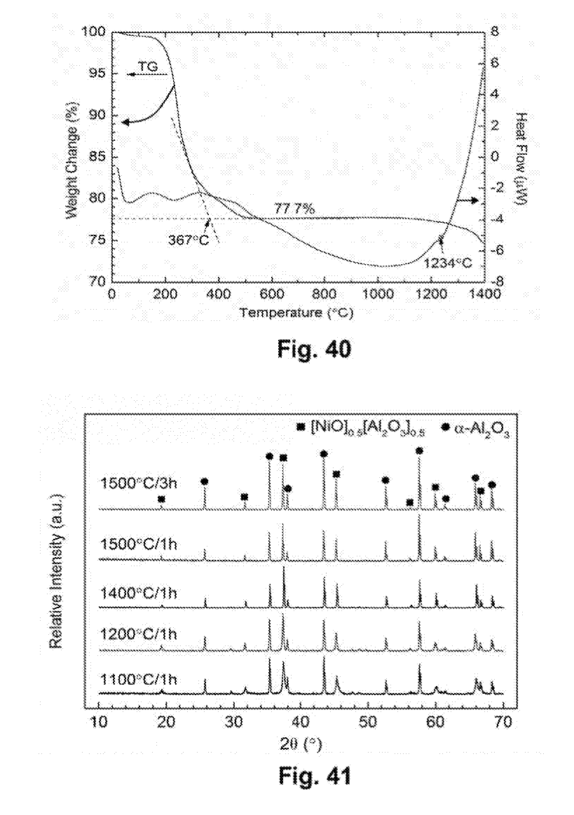

FIG. 40 provides TGA-DTA curves of as-cast [NiO]_{0.25}[Al₂O₃]_{0.75} green films heated in air. The sharp mass loss at ca. 370° C. arises due to decomposition of polymeric additives.

From Table 3, the expected ceramic yield of processed green films can be calculated as 78 wt. % (50 vol. %), excluding solvents as they would evaporate on drying. The TGA-DTA of FIG. 40 shows a ceramic yield identical to theory. Additionally, the exotherm at ca. 1230° C. is attributed to phase transformation as α-Al₂O₃ forms. Mass losses above 1200° C. can be ascribed to the slight volatility of NiO.

[NiO]_{0.25}[Al₂O₃]_{0.75} green films with thicknesses of 30±10 μm were sintered at temperatures up to 1500° C. As shown in the XRDs shown in FIG. 41, high temperatures (≥1100° C.) leads to segregation of α-Al₂O₃.

Sintered films consist of α-Al₂O₃ and [NiO]_{3.5}[Al₂O₃]_{0.5} spinel phases. δ-Al₂O₃ is isostructural with NiAl₂O₄ spinel allowing formation of solid solutions. On heating as-shot [NiO]_{0.25}[Al₂O₃]_{0.75} to the phase transformation temperature of α-Al₂O₃ (ca. 1150° C.), α-Al₂O₃ nucleates from Al₂O₃-rich spinel. Increased sintering temperatures lead to increases in α-Al₂O₃ contents, but at the expense of [NiO]_{0.5}[Al₂O₃]_{0.5} contents (Table 4). Films sintered at 1500° C./1 h/air consist of 71 wt. % α-Al₂O₃ and 29 wt. % [NiO]_{3.5}[Al₂O₃]_{0.5} phases. Longer dwell times do not change the relative phase compositions indicating complete phase segregation.

TABLE 4
Relative contents of phases in sintered [NiO]_{0.25}[Al₂O₃]_{0.75} films

| Temp. (° C.)/ | [NiO]_{0.5}[Al₂O₃]_{0.5} | α-Al₂O₃ |
|---|---|---|
| Time (h) | (wt %/mole %) | (wt %/mole %) |
| 1100/1 | 48.9/35.6 | 51.1/64.4 |
| 1200/1 | 41.7/29.2 | 58.3/70.8 |
| 1400/1 | 40.9/28.5 | 59.1/71.5 |
| 1500/1 | 29.2/19.2 | 70.8/80.8 |
| 1500/3 | 28.6/18.8 | 71.4/81.2 |

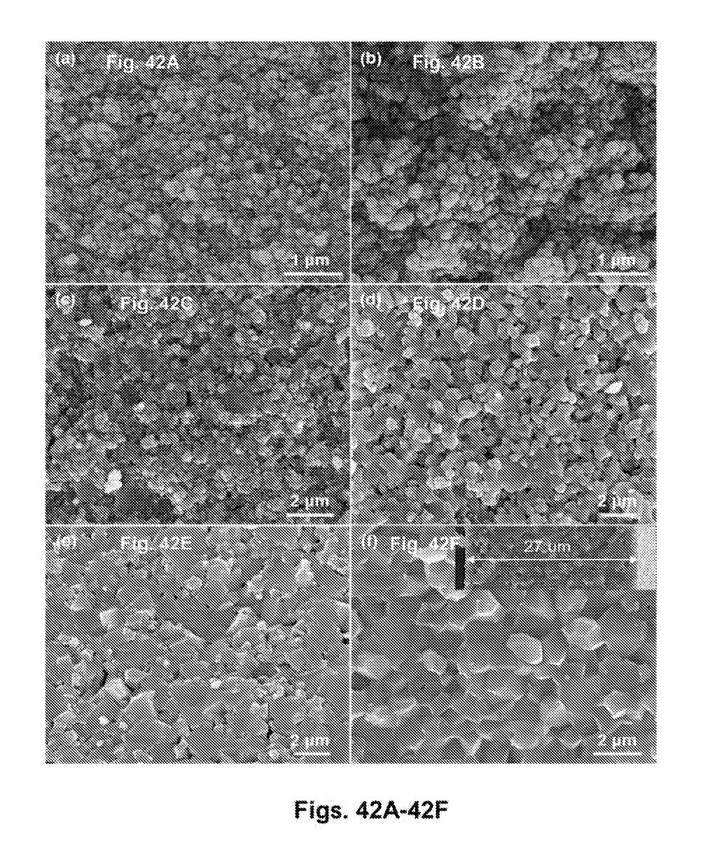

The SEMs of FIGS. 42A-42F show film fracture surface morphologies for [NiO]_{0.25}[Al₂O₃]_{0.75} after sintering at 1000-1500° C./air. No obvious sintering occurs below 1100° C. Nearly spherical, aggregated particles are retained in samples, just like as-shot powders. At 1200° C., larger islands >500 nm form within the [NiO]_{0.5}[Al₂O₃]_{0.5} spinel matrix, and show trans-granular fracture. These islands were proven to be α-Al₂O₃ by EDS (not shown here) and XRD (FIG. 41). This is reflected in TGA-DTA (FIG. 40).

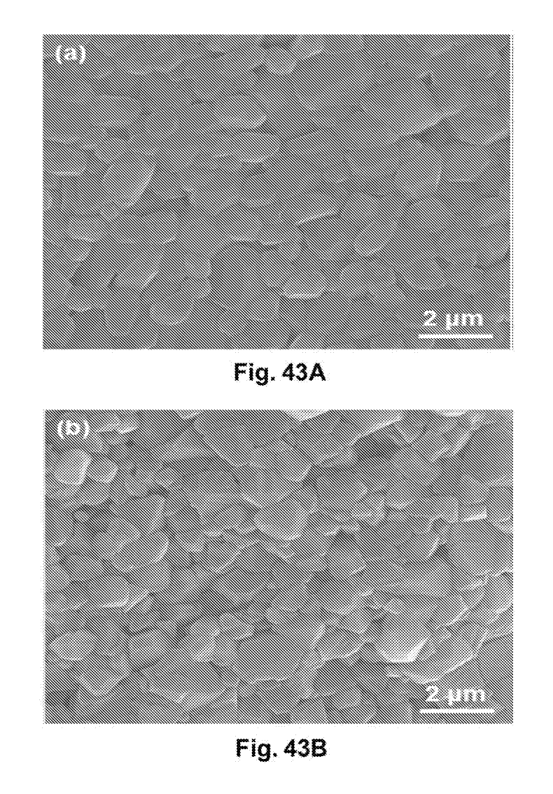

At 1400° C., all spherical morphologies disappear and obvious necks form between grains. Higher temperatures and longer dwell times induce more extensive sintering improving ceramic densification and promoting grain growth. Fully dense NiAl₂O₄—Al₂O₃ composite films with thicknesses of 30±2 μm are obtained at 1500° C./3 h. They offer densities of 95±2% TD per Archimedes' method. Additionally, trans- and inter-granular fractures are both present in film fracture surfaces. FIGS. 43A and 43B are SEM images showing thermally etched morphologies of [NiO]_{0.25}[Al₂O₃]_{0.75} films (as-sintered at 1500° C./3 h). Obvious grain boundaries are observed on film and fracture surfaces giving statistical average grain sizes of 1.1±0.3 μm.

The SEMs of FIGS. 42A-42F show fracture surface morphologies for [NiO]_{0.25}[Al₂O₃]_{0.75} films sintered in air at (FIG. 42A) 1000° C./1 h, (FIG. 42B) 1100° C./1 h, (FIG. 42C) 1200° C./1 h, (FIG. 42D) 1400° C./1 h, (FIG. 42E) 1500° C./1 h, (FIG. 42F) 1500° C./3 h.

[NiO]_{0.25}[Al₂O₃]_{0.75} Film Reduction

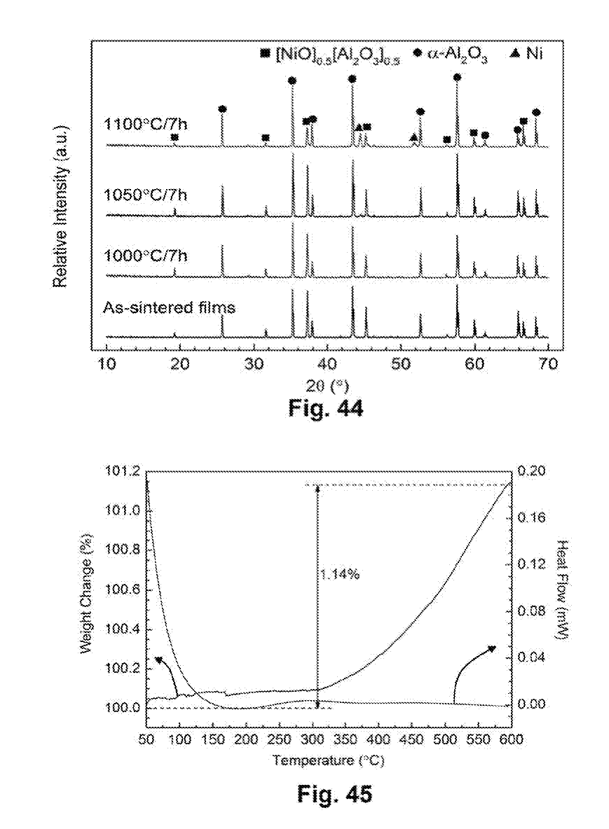

As-sintered, fully dense [NiO]_{0.25}[Al₂O₃]_{0.75} films were reduced in 5:95 H₂/N₂ to produce Ni particles on film surfaces targeting potential catalytic applications. The XRD of FIG. 44 shows no discernible peaks for Ni at 1000° C. and very weak peaks at 1050° C. indicating limited formation of Ni particles. In contrast, at 1100° C./7 h obvious Ni peaks rise at ca. 44.5° and 52° 2θ suggesting the formation of more Ni. Films after heating at 1100° C. turn completely black (optical images not shown) also indicating formation of Ni. XRD results show such films consist of 81.6 wt. % (83.9 mole %) Al₂O₃, 13.9 wt. % (8.2 mole %) [NiO]_{0.5}[Al₂O₃]_{0.5} and 4.4 wt. % (7.9 mole %) Ni. The TGA-DTA shown in FIG. 45 allows one to calculate formation of 3.7±1.0 wt. % Ni metal in as-reduced films.

As in the FIG. 41 XRDs and Table 4, [NiO]_{0.25}[Al₂O₃]_{0.75} films sintered at 1500° C. contain only 29 wt. % [NiO]_{0.5}[Al₂O₃]_{0.5} phase acting as the only source of Ni. Therefore, only small amounts of Ni NPs form in reduced films. Clearly more Ni particles can be produced in reduced [NiO]_{0.5}[Al₂O₃]_{0.5} films after sintering.

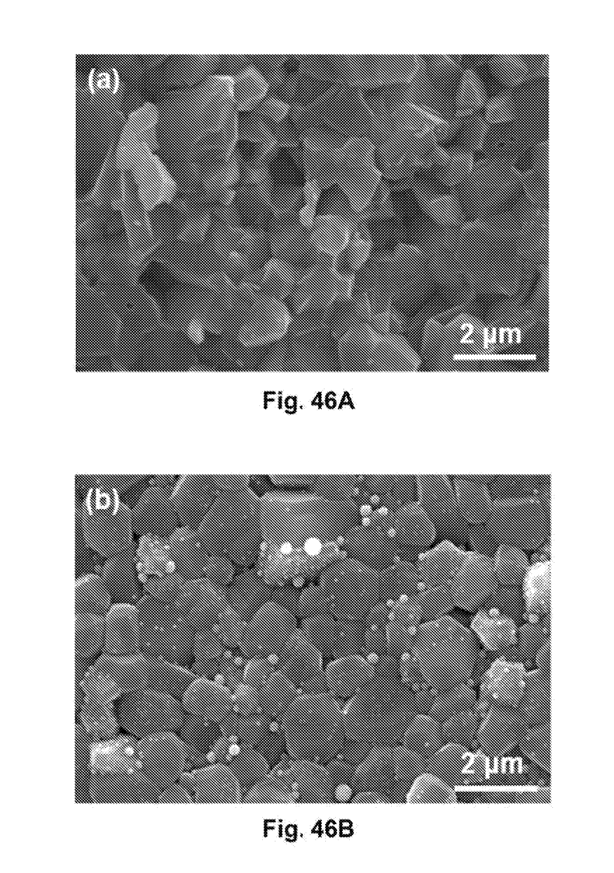

As shown in the SEM images of FIGS. 46A and 46B, no obvious morphology changes can be observed on film fracture surfaces after reduction. In contrast, a large white, spherical particles appear on film surfaces. They were confirmed to be Ni by EDS (not shown). Most Ni particles have sizes <100 nm. Additionally, some larger particles (100-300 nm) appear mainly around [NiO]_{0.5}[Al₂O₃]_{0.5} grains which seem to be porous due to Ni reduction. Such small sizes likely offer high Ni SSAs in principle thereby ensuring that most Ni particles on film surfaces will be catalytically active.

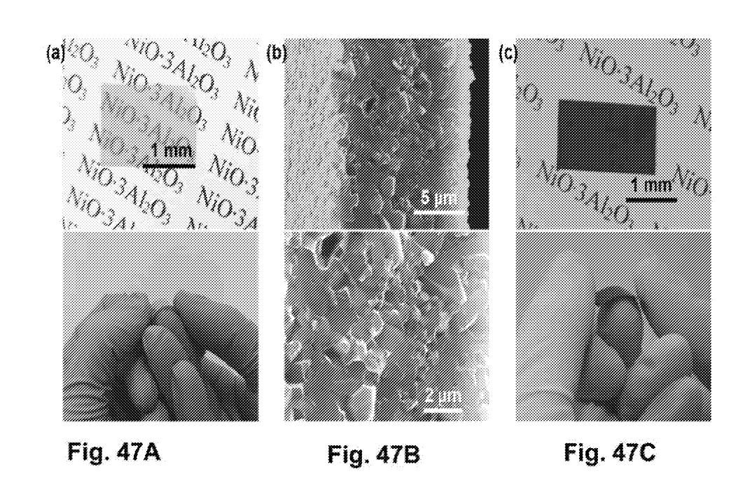

Thinner (<15 μm) films with larger dimensions (ca. 1.8×1.2 mm) were processed per the aforementioned procedures. The results are shown in FIGS. 47A-47C. These films are very dense and flexible after sintering in air or after reduction in H₂/N₂. This high flexibility is most likely due to the small strain in very thin deformed films. Trans-/inter-granular mixed fracture (vs. complete transgranular fracture) is also conducive to film flexibility. The excellent flexibility and thin NiAl₂O₄—Al₂O₃ films are potentially very attractive for SOFCs offering high and safe reliability especially for small footprint cells. Coincidently, thinner films that are mechanically robust, could also serve as excellent internal supports thereby reducing ohmic polarization losses potentially providing longer lifetimes of SOFCs.

[NiO]_{3.5}[Al₂O₃]_{0.5} Film Processing, Sintering and Reduction

To investigate the influence of chemical composition (NiO:Al₂O₃ 1:1 ratio) on the microstructures of the finally reduced films, [NiO]_{3.5}[Al₂O₃]_{0.5} films were processed similar to the methods used for [NiO]_{0.25}[Al₂O₃]_{0.75}. Dense [NiO]_{0.5}[Al₂O₃]_{0.5} films were obtained on sintering at 1550° C./3 h/air, then heated at 1100° C./7 h/H₂.

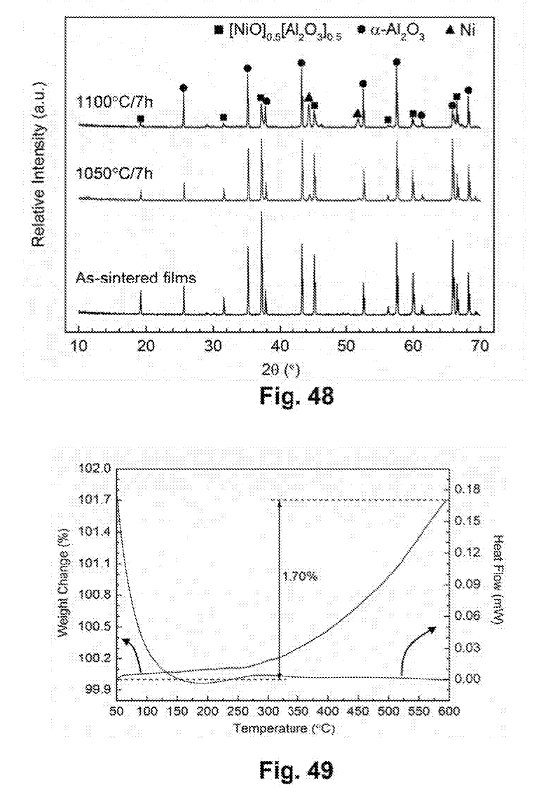

The XRDs of FIG. 48 show as-sintered [NiO]_{0.5}[Al₂O₃]_{0.5} films consist of the same phases as those in [NiO]_{0.25}[Al₂O₃]_{0.75}. Moreover, they contain 42.7 wt. % (30.1 mole %) [NiO]_{3.5}[Al₂O₃]_{0.5}, 14.1 wt. % (11.3 mole %) more than that (28.6 wt. %, 18.8 mole %) in [NiO]_{0.25}[Al₂O₃]_{0.75}. After heating in H₂, the relative intensities of the [NiO]_{3.5}[Al₂O₃]_{0.5} spinel peaks decrease significantly compared to those for as-sintered films. Increasing temperatures from 1050° to 1100° C. also leads to decreases in [NiO]_{3.5}[Al₂O₃]_{0.5} peak intensities indicating further reduction producing more Ni.

[NiO]_{3.5}[Al₂O₃]_{0.5} films, after heating at 1050° C., contain 2.6 wt. % Ni, while almost no Ni can be detected in [NiO]_{0.25}[Al₂O₃]_{0.75} on heating under the same conditions. At 1100° C., as-reduced [NiO]_{3.5}[Al₂O₃]_{0.5} films contain 9.6 wt. % Ni, ca. twice as much as that in [NiO]_{0.25}[Al₂O₃]_{0.75} (4.4 wt. %). Calculations per the TGA/-DTA data shown in FIG. 49 indicates 5.6±1.0 wt. % Ni was produced at 1100° C. as expected.

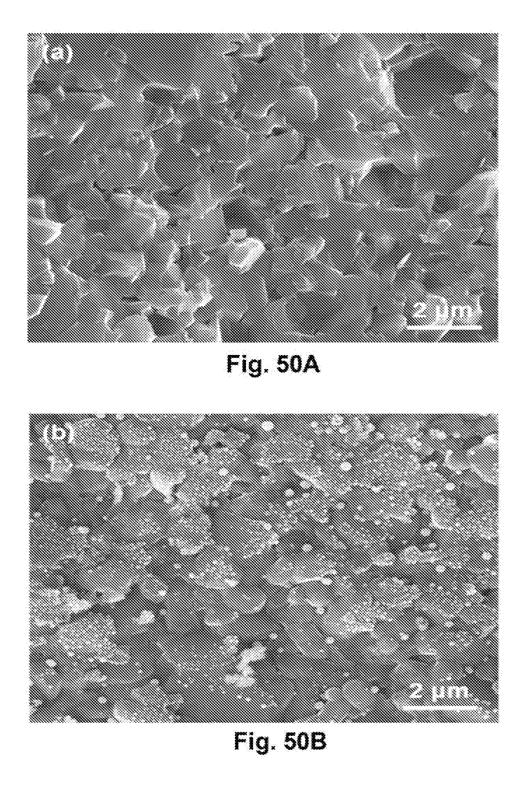

As seen in the SEM images shown in FIGS. 50A and 50B, as-reduced films show no obvious morphological changes on fracture surfaces. They still show mixed trans- and inter-granular fractures, just like as-sintered films. More Ni nanoparticles are observed on [NiO]_{0.5}[Al₂O₃]_{0.5} film surfaces compared to [NiO]_{0.25}[Al₂O₃]_{0.75}, in accordance with the results shown in FIGS. 10 and 11. Therefore, more Ni nanoparticles will provide theoretically better catalytic properties as long as they do not sinter during use.

The utility of liquid-feed flame spray pyrolysis (LF-FSP) NiO—Al₂O₃ nanopowders is extended to processing NiAl₂O₄—Al₂O₃ and Ni—Al₂O₃ dense and flexible thin films with value as electrodes and catalysts in solid oxide fuel cells (SOFCs). LF-FSP provides NiAl₂O₄ single phase nanopowders with limited aggregation. Nearly fully dense NiAl₂O₄—Al₂O₃ composite films with average grain sizes of 1.1±0.3 μm were obtained at 1500° C./3 h due to α-Al₂O₃ segregation above 1100° C. Sufficient Ni nanoparticles form on film surfaces after heating at 1100° C./7 h in H₂ providing catalytic activity. Compared to [NiO]_{0.25}[Al₂O₃]_{0.75}, as-sintered NiAl₂O₄—Al₂O₃ films derived from LF-FSP [NiO]_{0.5}[Al₂O₃]_{0.5} powders contain more [NiO]_{0.5}[Al₂O₃]_{0.5} phases leading to formation of more Ni nanoparticles after film reduction, thereby allowing theoretically higher catalytic activity. High densities (95±2% TD), excellent flexibilities and thin thicknesses (20±7) of films make it possible for SOFCs to provide high safe reliability and small units.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of making a thin film, the method comprising:
ball milling a suspension comprising a nanopowder, an additive component, and a solvent to generate a suspension of milled nanopowder, wherein the additive component is selected from the group consisting of a dispersant, a binder, a plasticizer, and combinations thereof;
disposing a layer of the suspension of milled nanopowder onto a substrate;
drying the layer by removing at least a portion of the solvent to form a green film;
compressing the green film to form a compressed green film;
debindering the compressed green film to form a debindered film; and
sintering the debindered film to generate the thin film.

2. The method according to claim 1, wherein the nanopowder comprises nanopowder particles having an average diameter of less than or equal to about 500 nm.

3. The method according to claim 1, wherein the nanopowder is made by liquid-feed flame spray pyrolysis, co-precipitation, or sol-gel synthesis.

4. The method according to claim 1, wherein the nanopowder comprises nanopowder particles comprising a material selected from the group consisting of oxides, carbonates, carbides, nitrides, oxycarbides, oxynitrides, oxysulfides, and combinations thereof.

5. The method according to claim 1, wherein the solvent comprises water, methanol, ethanol, propanol, butanol, xylene, hexane, methyl ethyl ketone, acetone, toluene, or a combination thereof.

6. The method according to claim 1, wherein the additive component comprises a dispersant selected from the group consisting of polyacrylic acid, bicine, citric acid, steric acid, fish oil, phenylphosphonic acid, phosphoric acid, ammonium polymethacrylate, organosilanes, and combinations thereof.

7. The method according to claim 1, wherein the additive component comprises a binder selected from the group consisting of polyvinyl butyral, polyvinyl acetate, methyl cellulose, ethyl cellulose, polyacrylate esters, polyurethane, polyethylene glycol, acrylic compounds, polystyrene, polyvinyl alcohol, polymethylmethacrylate, polybutylmethacrylate, and combinations thereof.

8. The method according to claim 1, wherein the additive component comprises a plasticizer selected from the group consisting of benzyl butyl phthalate, acetic acid alkyl esters, bis[2-(2-butoxyethoxy)ethyl] adipate, 1,2-Dibromo-4,5-bis(octyloxy)benzene, dibutyl adipate, dibutyl itaconate, dibutyl sebacate, dicyclohexyl phthalate, diethyl adipate, diethyl azelate, di(ethylene glycol) dibenzoiate, diethyl sebacate, diethyl succinate, diheptyl phthalate, diisobutyl adipate, diisobutyl fumarate, diisobutyl phthalate, diisodecyl adipate, diisononyl phthalate, dimethyl adipate, dimethyl azelate, dimethyl phthalate, dimethyl sebacate, dioctyl terephthalate, diphenyl phthalate, di(propylene glycol) dibenzoate, dipropyl phthalate, ethyl 4-acetylbutyrate, 2-(2-ethylhexyloxy)ethanol, isodecyl benzoate, isooctyl tallate, neopentyl glycol dimethylsulfate, 2-nitrophenyl octyl ether, poly(ethylene glycol) bis(2-ethylhexanoate), poly(ethylene glycol) dibenzoate, poly(ethylene glycol) dioleate, poly(ethylene glycol) monolaurate, poly(ethylene glycol) monooleate, poly(ethylene glycol) monooleate, sucrose benzoate, 2,2,4-trimethyl-1,3-pentanediol dibenzoate, trioctyl timelitate, and combinations thereof.

9. The method according to claim 1, wherein the suspension has a nanopowder concentration of greater than or equal to about 5 vol. % to less than or equal to about 50 vol. %.

10. The method according to claim 1, wherein the disposing is performed by bar coating, wire wound rod coating, drop casting, spin coating, doctor blading, dip coating, or spray coating.

11. The method according to claim 1, wherein, after the drying and before the sintering, the method further comprises:
removing the green film from the substrate; and
cutting the green film into a predetermined shape and size.

12. The method according to claim 11, further comprising:
disposing the green film onto either a second green film or onto a metal foil to form a green bilayer film, and
compressing, and debindering the green bilayer film to form a debindered bilayer film, and
sintering the debindered bilayer film to form the thin film,
wherein the thin film is a bilayer composite thin film.

13. The method according to claim 12, wherein the bilayer composite thin film comprises a first side comprising a ceramic with a rare earth element dopant, and an opposing second side comprising a metal, wherein the first side is thermo-luminescent.

14. The method according to claim 1, wherein the nanopowder comprises at least one of Li_{6.25}Al_{0.25}La₃Zr₂O₁₂ and Li_{6.25}Ga_{0.25}La₃Zr₂O₁₂, and prior to the ball milling, the method further comprises generating the nanopowder by:
aerosolizing and combusting a solution comprising a lithium propionate, alumatrane or gallium-atrane, lanthanum isobutyrate, and zirconium isobutyrate in an oxidizing atmosphere using liquid-feed flame spray pyrolysis to generate a nanopowder comprising Li_{6.25}Al_{0.25}La₃Zr₂O₁₂ nanoparticles or Li_{6.25}Ga_{0.25}La₃Zr₂O₁₂ nanoparticles.

15. A thin film generated by the method according to claim 1.

16. A method of making a thin film, the method comprising:
combining a nanopowder generated by liquid-feed flame spray pyrolysis with a solvent, a binder, and a plasticizer to generate a nanopowder suspension, the nanopowder comprising nanoparticles have an average diameter of less than or equal to about 500 nm;
ball milling the nanopowder suspension for a time of greater than or equal to about 6 hours to less than or equal to about 48 hours using a milling media comprises a material contained in the nanopowder to generate a milled suspension;
casting a layer of the milled suspension on a substrate by bar coating or wire wound rod coating;
drying the layer by on the substrate by removing at least a portion of the solvent to form a green film;
thermo-compressing the green film using a uni-axial press, a bi-axial press, a tri-axial press, or a roll press to form a compressed green film;
debindering the compressed green film to form a debindered film; and
sintering the debindered film to form the thin film.

17. The method according to claim 16, further comprising, after the removing and prior to the thermo-compressing:
disposing the green film on a second green film made by the same method but with a different nanopowder,
wherein after the sintering a composite thin film comprising a plurality of layers is generated.

18. The method according to claim 16, wherein the nanopowder suspension includes a dopant.

19. The method according to claim 16, wherein the substrate comprises a biaxially-oriented polyethylene terephthalate.

20. The method according to claim 16, wherein the thin film has a thickness of greater than or equal to about 1 μm to less than or equal to about 100 μm.
